(19) United States
(12) Patent Application Publication
(10) Pub. No.: US 2004/0252077 A1
(43) Pub. Date: Dec. 16, 2004

(54) Display

(76) Inventor: Hajime Terasaki, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/485,151

(22) PCT Filed: Jul. 29, 2002
(86) PCT No.: PCT/JP02/07683

(30) Foreign Application Priority Data
Jul. 31, 2001 (JP) 2001-232549

(51) Int. Cl. G09G 5/00

(52) U.S. Cl. 345/8

(57) ABSTRACT

A display device which is to be mounted on the head and can ensure as wide an external field of view as possible even when mounted on the head is provided.

The display device A1 has a frame section 10 of eyeglass type, support sections 30a, 30b, and microdisplay units 40a, 40b. Specifically, the support sections 30a, 30b are attached to lower ends of the edge sections 14a, 14b of a rim section 12 of a frame section 10, and microdisplay units 40a, 40b are supported so as to be pivotable with respect to the support sections 30a, 30b.

### TECHNICAL FIELD

The present invention relates to a display device, and more particularly, to a display device to be used while being mounted on the user's head.

### BACKGROUND ART

A goggle-type display device has hitherto been available as a display device to be used while being mounted on the user's head.

However, the goggle-type display device fails to ensure an external field of view and also fails to yield a so-called see-around effect of ensuring the field of view outside that achieved by the display device.

Therefore, the present invention relates to a display device to be mounted on the head and aims at providing a display device capable of ensuring as wide an external field of view as possible even when mounted on the head.

### DISCLOSURE OF THE INVENTION

The invention has been conceived to solve the drawbacks and is first characterized by a display device comprising: a frame section of eyeglass type having a rim section, the rim section being located in front of a user's face when the display device is mounted on the head, and a pair of temple sections connected to respective sides of the rim section; and a display section which is attached to the frame section and has a microdisplay.

The display device of the first configuration has a frame section of eyeglass type, and a display section attached to the frame section. When the display device is worn, only the frame section and the support section other than the display sections obstruct the user's field of view. Hence, a field of view outside the display sections can be ensured sufficiently. Even when an action for viewing documents or the like is performed while the display device is used, the only requirement is to change merely the direction of the line of sight, and hence the display device can be made superior in operability.

Secondly, the first configuration is characterized in that the rim section has downward portions which are located side by side at positions downward of the user's eyes when the display device is mounted on the head, and the display section is attached to each of the downward portions.

According to the display device of the second configuration, the display section can be provided at a position downward of the user's front line of sight, thereby rendering the display device easy for the user to use. Specifically, since the human eye can easily view a position slightly downward rather than viewing the front, the display device can be made easy for the user to view by providing the display section at a position downward of the user's front line of sight.

Thirdly, the first configuration is characterized in that the rim section has interior portions which are situated at positions within an area between the user's eyes when the display device is mounted on the head, and the display section is attached to the interior sections.

The display device of the third configuration enables the user to obtain a sufficient see-around effect. Specifically, the support section is attached to the interior portion, and hence the left field of view for the user's right eye is obstructed. However, the left field of view is observed by the left eye, and hence obstruction of the left field of view of the right eye does not pose any substantial problem. Similarly, the right field of view for the user's left eye is obstructed. However, the right field of view is observed by the right eye, and hence obstruction of the right field of view of the left eye does not pose any substantial problem. As mentioned above, the user can obtain a sufficient see-around effect. The third configuration may be embodied such that the display section is provided at a center portion of the rim section in a lateral direction thereof.

Fourth, the first configuration is characterized in that the display section is attached to the frame section so as to be rotatable about a lateral axis of the display device with respect to the frame section. The orientation of the display section can be adjusted by means of vertical rotation.

Fifth, the first configuration is characterized in that the display section is provided at a position downward of a front direction of the user who has worn the display device. As a result, the display device can be made easy for the user to use. Specifically, since the human eye can easily view a position slightly downward rather than viewing the front, the display device can be made easy for the user to view by providing the display section at a position downward of the user's front line of sight.

Sixth, the first configuration is characterized in that the display section is attached to the frame section so as to be movable in a moving direction having vertical components of the display device. As a result, the vertical position of the display section can be adjusted.

Seventh, the first configuration is characterized in that the display section is attached to the frame section so as to be movable over a circular-arc-shaped travel path which is movable, with respect to the frame section, in a moving direction having vertical components of the display device. As a result, the display section is made movable along a circular path concentric with the rotational center of the user's eyeballs, whereby the user can well view an image displayed on the display section at any position even after the display section has been moved.

In addition, the first configuration can be characterized in that the display section is provided at a lower end of the rim section. In this case, the display section can be provided at a position downward of the user's front line of sight, thereby rendering the display device easy for the user to utilize. Specifically, since the human eye can easily view a position slightly downward rather than viewing the front, the display device can be made easy for the user to view by providing the display section at a position downward of the user's front line of sight.

The first configuration may be embodied as a structure, wherein the frame section has a slide path section over which the display section slides, which supports the display section in a movable manner, and which enables sliding over a travel path movable in a moving direction having vertical components of the display device. In this case, the vertical position of the display section can be adjusted. Further, the travel path may be located on a circular arc.

The configurations dependent on the first configuration may be made further dependent on other configurations dependent on the first configuration.

Eighth, a display device is characterized comprising: a rim section having a removal/attachment mechanism to be used for removal attachment of the display device to eyeglasses; and a display section which is mounted on the rim section and has a microdisplay.

In the display device of the eighth configuration, the rim section is provided with the display section. Hence, when the display device is in use, the display device is used after having been attached to eyeglasses by means of the removal/attachment mechanism. When the display device is worn, only the rim section and the support section other than the display sections obstruct the field of view. Hence, a field of view outside the display sections can be ensured sufficiently. Even when an action for viewing documents or the like is performed while the display device is used, the only requirement is to change merely the direction of the user's line of sight, and hence the display device can be made superior in operability.

The eighth configuration may be combined with the foregoing configurations dependent on the first configuration. Namely, the eighth configuration is characterized in that the rim section has downward portions which are located side by side at positions downward of the user's eyes when the display device is mounted on the head, and the display section is attached to each of the downward portions. Moreover, the eighth configuration is characterized in that the rim section has interior portions which are situated at positions within an area between the user's eyes when the display device is mounted on the head, and the display section is attached to the interior sections. In addition, the eighth configuration is characterized in that the display section is attached to the frame section so as to be rotatable about a lateral axis of the display device with respect to the frame section. Further, the eighth configuration is characterized in that the display section is provided at a position downward of a front direction of the user who has worn the display device. Moreover, the eighth configuration is characterized in that the display section is attached to the frame section so as to be movable in a moving direction having vertical components of the display device. The eighth configuration is also characterized in that the display section is attached to the frame section so as to be movable along a circular-arc travel path on which the display section can move in a travel direction including vertical components of the display device with respect to the frame section. Further, the eighth configuration is characterized in that the display section is provided at a lower end of the rim section. In addition, the eighth configuration is characterized in that the frame section has a slide path section over which the display section slides, which supports the display section in a movable manner, and which enables sliding over a travel path movable in a moving direction having vertical components of the display device.

The configurations dependent on the eighth configuration may be made further dependent on other configurations dependent on the eighth configuration.

Ninth, a display device is characterized by comprising: a frame section of eyeglass type having a rim section, the rim section being located in front of a user's face when the display device is mounted on the head, and a pair of temple sections connected to respective sides of the rim section; a support section attached to the frame section; and a display section which is attached to the support section and has a microdisplay.

The display device of the ninth configuration has the frame section of eyeglass type, and the display section is attached to the frame section by way of the support section. When the display device is worn, only the frame section and the support section other than the display sections obstruct the user's field of view. Hence, a field of view outside the display sections can be ensured sufficiently. Even when an action for viewing documents or the like is performed while the display device is used, the only requirement is to change merely the direction of the user's line of sight, and hence the display device can be made superior in operability.

The ninth configuration may be embodied as follows. Specifically, the configuration is embodied as a display device comprising: an eyeglass-shaped main body section of eyeglass type; a support section attached to the main body section of eyeglass type; and a display section which is attached to the support section and has a microdisplay. Further, a configuration to be made dependent on the configuration may be embodied such that the main body section of eyeglass type has a first configuration section having a portion to be situated at least in front of the face when the display device is mounted on the head; and a pair of second configuration sections which are connected to respective sides of the first configuration section and assume the shape of temples of eyeglasses. Alternatively, the configuration may be embodied such that the main body section of eyeglass type assumes the shape of a frame and such that the main body section of eyeglass type has a first configuration section which has a portion to be situated at least in front of the face when the display device is mounted on the head and the shape of a rim; and a pair of second configuration sections which are connected to respective sides of the first configuration section and assume the shape of a temple section of eyeglasses. In this case, the main body section of eyeglass type corresponds to a frame section 10 described in the following embodiments; the first configuration section corresponds to a rim section 12 described in the following embodiments; and the second configuration section corresponds to temple sections 20a, 20b.

Tenth, the ninth configuration is characterized in that the rim section has downward portions which are located side by side at positions downward of the user's eyes when the display device is mounted on the head, and the support section is attached to each of the downward portions. Accordingly, the display section can be provided at a position downward of the front line of the user's sight, thereby rendering the display device easy for the user to use. Specifically, since the human eye can easily view a positions lightly downward rather than viewing the front, the display device can be made easy for the user to view by providing the display section at a position downward of the user's front line of sight.

Eleventh, the ninth configuration is characterized in that the rim section has interior portions which are situated at positions within an area between the user's eyes when the display device is mounted on the head, and the support section is attached to the interior sections. As a result, the user can obtain a sufficient see-around effect. Specifically, the support section is attached to the interior portion, and hence the left field of view for the user's right eye is obstructed. However, the left field of view is observed by the left eye, and hence obstruction of the left field of view of the right eye does not pose any substantial problem. Similarly, the right field of view for the user's left eye is obstructed. However, the right field of view is observed by the right eye, and hence obstruction of the right field of view of the left eye does not pose any substantial problem. As mentioned above, the user can obtain a sufficient see-around effect.

Twelfth, the ninth configuration is characterized in that the display section is attached to the support section so as to be rotatable about a lateral axis of the display device with respect to the support section. The orientation of the display section can be adjusted by means of vertical rotation.

Thirteenth, the ninth configuration is characterized in that the display section is provided at a position downward of a front direction of the user who has worn the display device. As a result, the display device can be made easy for the user to use. Specifically, since the human eye can easily view a position slightly downward rather than viewing the front, the display device can be made easy for the user to view by providing the display section at a position downward of the user's front line of sight.

Fourteenth, the ninth configuration is characterized in that the display section is attached to the support section so as to be movable in a moving direction having vertical components of the display device. The vertical position of the display section can be adjusted.

Fifteenth, the ninth configuration is characterized in that the display section is attached to the support section so as to be movable over a circular-arc-shaped travel path which is movable in a moving direction having vertical components of the display device, with respect to the support section. As a result, the display section is made movable along a circular path concentric with the rotational center of the user's eyeballs, whereby the user can well view an image displayed on the display section at any position even after the display section has been moved.

Sixteenth, the ninth configuration is characterized in that the support section is attached to the frame section so as to be movable in a moving direction having vertical components of the display device. Hence, the vertical position of the display section can be adjusted.

Seventeenth, the ninth configuration is characterized in that the support section is attached to the frame section so as to be movable over a circular-arc-shaped travel path which is movable in a moving direction having vertical components of the display device. As a result, the display section is made movable along a circular path concentric with the rotational center of the user's eyeballs, whereby the user can well view an image displayed on the display section at any position even after the display section has been moved.

Eighteenth, the ninth configuration is characterized in that the support section is removable from the frame section.

Nineteenth, the ninth configuration is characterized in that the support section is rotatably supported by the temple section of the frame section. Hence, as a result of rotation of the support section, the vertical positions of the display sections can be adjusted. Further, when the display sections have become interruptive, the only requirement is to rotate the support section, thereby improving the overall operability of the display device.

Twentieth, the fifteenth configuration is characterized in that the circular-arc-shaped travel path is located on a circular arc centered at the rotational center of eyeballs of the user who has worn the display device. As a result, the user can well view an image displayed on the display section at any position even after the display section has been moved.

Twenty-first, the fifteenth configuration is characterized in that the circular-arc-shaped travel path has a radius of 20 mm to 45 mm. As a result, the display section is made movable along a circular path concentric with the rotational center of the eyeballs of the user who wears the display device, whereby the user can well view an image displayed on the display section at any position even after the display section has been moved.

Twenty-second, the nineteenth configuration is characterized in that the support section is slidably supported by the temple section. As a result, it becomes easy for the user to adjust the image displayed on the display section to an easily-viewable position.

Twenty-third, the nineteenth configuration is characterized in that the position where the support section is supported by the temple section is separated from an end section of the temple section close to the rim section by 20 mm to 45 mm. As a result, the display section is made movable along a circular path concentric with the rotational center of the eyeballs of the user who wears the display device, whereby the user can well view an image displayed on the display section at any position even after the display section has been moved by means of rotating the support section.

Twenty-fourth, the nineteenth configuration is characterized in that the rim section has at each end thereof an endpiece section to be used for connecting the rim section with the temple section, and the location where the support section is supported by the temple section is located at an end section of the endpiece section and separated from a forward end section of the display device by 20 mm to 45 mm. As a result, the display section is made movable along a circular path concentric with the rotational center of the eyeballs of the user who wears the display device, whereby the user can well view an image displayed on the display section at any position even after the display section has been moved by means of rotating the support section.

In addition, the ninth configuration or any of the configurations dependent on the ninth configuration can be characterized in that the support section is provided at a lower end of the rim section. In this case, the display section can be provided at a position downward of the user's front line of sight, thereby rendering the display device easy for the user to view. Specifically, since the human eye can easily view a positions lightly downward rather than viewing the front, the display device can be made easy for the user to view by providing the display section at a position downward of the user's front line of sight.

Additionally, as an additional configuration, the ninth configuration or any of the configurations dependent on the ninth configuration may be characterized in that the support section has a slide path section over which the display section slides, which supports the display section in a movable manner, and which enables sliding over a travel path movable in a moving direction having vertical components of the display device. In this case, the vertical position of the display section can be adjusted. The additional configuration may also be characterized in that the support section further has a bearing section which enables the slide path section to rotate about the lateral axis of the display device. In this case, the vertical position of the display section can be adjusted. The additional configuration may also be characterized in that the support section is a bearing section which has a universal joint mechanism and enables rotation of the slide path section. In this case, the orientation of the display section can be adjusted by means of rotating the slide path section through 360°. Further, the additional configuration may be characterized in that the travel path is located on a circular arc. In this case, the display section is made movable along a circular path concentric with the rotational center of the user's eyeballs, whereby the user can well view an image displayed on the display section at any position even after the display section has been moved.

Additionally, the ninth configuration or any of the configurations dependent on the ninth configuration may be characterized in that the frame section has a slide path section over which the support section slides, which supports the support section in a movable manner, and which enables sliding over a travel path movable in a moving direction having vertical components of the display device. In this case, the vertical position of the display section can be adjusted.

In addition, the ninth configuration or any of the configurations dependent on the ninth configuration may be characterized in that the support section has a first L-shaped member which is pivotally supported by a right-side temple section and supports a display section for a right eye, and a second L-shaped member which is pivotally supported by a left-side temple section and supports a display section for a left eye. Further, the additional configuration may be characterized in that the first L-shaped member has a first support section for supporting the display section, and a second support section which is pivotally supported by the right-side temple section and is removably attached to the first support section; and in that the second L-shaped member has a third support section for supporting the display section, and a fourth support section which is pivotally supported by the left-side temple section and is removably attached to the third support section. As a result, the support section can be separated into a portion for supporting the display section and another portion supported by the temple section. When the temple sections are collapsed, collapsing action can be performed without involvement of a problem.

In addition, the nineteenth configuration or any of the configurations dependent on the nineteenth configuration may be characterized in that the position at which the support section is supported by the temple section is situated beside the rotational center of the eyeballs of the user wearing the display device. Therefore, when the display section has been moved by pivoting the support section, the images displayed on the display sections can be viewed by the user at any position achieved after movement.

Any of the configurations dependent on the ninth configuration may also be made dependent on other configurations dependent on the ninth configuration.

Twenty-fifth, a display device is characterized by comprising: a rim section having a removal/attachment mechanism to be used for removal attachment of the display device to eyeglasses; a support section attached to the rim section; and a display section which is attached to the support section and has a microdisplay.

In the display device having the twenty-fifth configuration, the rim section is provided with the display section. Hence, when the display device is in use, the display device is used after having been attached to eyeglasses by means of the removal/attachment mechanism. When the display device is worn, only the rim section and the support section other than the display sections obstruct the field of view. Hence, a field of view outside the display sections can be ensured sufficiently. Even when an action for viewing documents or the like is performed while the display device is used, the only requirement is to change merely the direction of the line of sight, and hence the display device can be made superior in operability.

The twenty-fifth configuration may also be embodied as follows. Namely, a display device is characterized by comprising: a first rim-shaped structure section having a removal/attachment mechanism for enabling removal and attachment of the display device from and to eyeglasses; a support section attached to the first structure section; and a display section attached to the support section and having a microdisplay.

The twenty-fifth configuration may also be combined with any of the features dependent on the ninth configuration. More specifically, the twenty-fifth configuration is characterized in that the support section is provided at a lower end of the rim section. Further, the twenty-fifth configuration is characterized in that the rim section has downward portions which are located side by side at positions downward of the user's eyes when the display device is mounted on the head, and the support section is attached to each of the downward portions. Moreover, the twenty-fifth configuration is characterized in that the rim section has interior portions which are situated at positions within an area between the user's eyes when the display device is mounted on the head, and the support section is attached to the interior sections. In addition, the twenty-fifth configuration is characterized in that the display section is attached to the support section so as to be rotatable about a lateral axis of the display device with respect to the support section. Further, the twenty-fifth configuration is characterized in that the display section is provided at a position downward of a front direction of the user who has worn the display device. Moreover, the twenty-fifth configuration is characterized in that the display section is attached to the support section so as to be movable in a moving direction having vertical components of the display device. Further, the twenty-fifth configuration is characterized the display section is attached to the support section so as to be movable over a circular-arc travel path which enables a travel in a moving direction having vertical components of the display device. The twenty-fifth configuration is characterized in that the support section is attached to the frame section so as to be movable in a travel direction having vertical components of the display device. Further, the twenty-fifth configuration is characterized in that the support section is attached to the frame section so as to be movable over a circular-arc slide path which enables travel in a travel direction having vertical components of the display device. The twenty-fifth configuration is also characterized in that the support section is removably attached to the frame section. The twenty-fifth configuration is also characterized in that the circular-arc travel path is on a circular arc centered at the rotational center of the eyeballs of the user wearing the display device. The twenty-fifth configuration is also characterized in that the diameter of the circular-arc travel path is 20 mm to 45 mm.

In addition, as an additional configuration, the twenty-fifth configuration or any of the configurations dependent on the twenty-fifth configuration may be characterized in that the support section has a slide path section over which the display section slides, which supports the display section in a movable manner, and which enables sliding over a travel path movable in a moving direction having vertical components of the display device. In addition, the twenty-fifth configuration is characterized in that the support section has a bearing section which enables rotation about a lateral axis of the display device. Further, the additional configuration may also be characterized in that the support section further has a bearing section which has a universal joint mechanism and permits pivotal movement of the slide path section. Moreover, the additional configuration may also be characterized in that the travel path is on a circular arc. Moreover, the twenty-fifth configuration or any of the configurations dependent on the twenty-fifth configuration is characterized in that the frame section has a slide path section over which the support section slides, which supports the support section in a movable manner, and which enables sliding over a travel path movable in a moving direction having vertical components of the display device. In this case, the vertical positions of the display section can be adjusted.

Any of the configurations dependent on the twenty-fifth configuration may also be made dependent on the other configurations dependent on the twenty-fifth configuration.

Twenty-sixth, a display device is characterized by comprising: a display section having a microdisplay; and a main body section which supports the display section and has a pair of temple sections, the temple sections coming into contact with respective sides of a user's head when the display device is worn, and a support section, the support section being rotatably supported by the temple sections and supporting the display section.

In the display device having the twenty-sixth configuration, when only the images displayed on the display sections are viewed, the support sections are not made angled with respect to the temple sections. When the user desires to view other portions along with the images displayed on the display sections, the support sections are made angled with respect to the temple sections. As a result, the mode of the display device can be selected in accordance with the operating state of the display device. Further, when the display device is worn, only the main body section other than the display sections obstructs the field of view, and hence the field of view outside the display sections can be sufficiently ensured.

Twenty-seventh, the twenty-sixth configuration is characterized in that the support section has a first support section which is rotatably supported by a right temple section and supports a right display section; a second support section which is rotatably supported by a left temple section and supports a left display section; and a third support section for supporting the right display section and the left display section.

In addition, as an additional configuration, the twenty-sixth or twenty-seventh configuration may be characterized in that the third support section is provided with nose pad sections which come into contact with the user's nose when the display device is worn. Further, the twenty-sixth configuration, the twenty-seventh configuration, and the additional configuration may be characterized in that the position at which the support section is supported by the temple section is situated beside the rotational center of the eyeballs of the user wearing the display device.

The respective configurations may be characterized in that the display section is formed from a total of two microdisplay devices, which are for left and right eyeballs, respectively.

Twenty-eighth, a display device is characterized by comprising: a support section having a removal/attachment mechanism for removal attachment of the display device from and to eyeglasses; and a display section which is supported by the support section and has a microdisplay.

In the display device having the twenty-eighth configuration, the support section is provided with a removal/attachment mechanism for enabling removal attachment of the display device to eyeglasses. Hence, when the display device is in use, the display device is used after having the support section been attached to eyeglasses by means of the removal/attachment mechanism. Hence, a field of view outside the display sections can be ensured sufficiently. Even when an action for viewing documents or the like is performed while the display device is used, the only requirement is to change merely the direction of line of sight, and hence the display device can be made superior in operability. Further, the display device can be attached to the eyeglasses, and hence a user who ordinarily uses eyeglasses can attach the display sections by utilization of the eyeglasses, thus providing convenience.

Twenty-ninth, the twenty-eighth configuration is characterized in that the display section is rotatably attached to the support section. As a result, the orientation of the display section can be adjusted.

Thirtieth, the twenty-eighth configuration is characterized in that the display section is attached to the support section so as to be movable over the support section. Hence, the position of the display section can be adjusted.

The twenty-eighth configuration or any of the configurations dependent on the twenty-eighth configuration may be characterized in that the support section is removably attached to the rim section of eyeglasses. In this case, the support section is attached to the rim section, and hence the area of the field of view which would be obstructed can be minimized.

The twenty-eighth configuration or any of the configurations dependent on the twenty-eighth configuration may be characterized in that the display section is movable over a circular-arc travel path and attached to the support section. In this case, the display section is made movable along a circular path concentric with the rotational center of the user's eyeballs, whereby the user can well view an image displayed on the display section at any position even after the display section has been moved.

The twenty-eighth configuration or any of the configurations dependent on the twenty-eighth configuration may be characterized in that the support section has a slide path section over which the display section slides, which supports the display section in a movable manner, and which enables sliding over a travel path movable in a moving direction having vertical components of the display device. In this case, the position of the display section can be adjusted. Moreover, the support section may have a bearing section for supporting the slide path section rotatably. In this case, the orientation of the display section can be adjusted by rotation of the slide section. Further, the support section has a bearing section which has a universal joint mechanism and enables pivotal movement of the slide path section. In this case, the orientation of the display section can be adjusted by rotating the slide path section through 360°.

The fourteenth configuration or any of the subsequent configurations may also be characterized in that the display section is removable with respect to the support section.

### BRIEF DESCRIPTION OF THE DRAWINGS

FIG. 1 is a perspective view of a display device according to a first embodiment of the invention;

FIG. 2 is a perspective view of the display device according to the first embodiment of the invention;

FIG. 3 is an exploded perspective view of the display device according to the first embodiment of the invention;

FIG. 4 is a cross-sectional view of the principal section of the display device according to the first embodiment of the invention, particularly a cross-sectional view taken along line X-X shown in FIG. 1;

FIG. 5 is an enlarged perspective view of the principal section of the display device according to the first embodiment of the invention;

FIG. 6 is a cross-sectional view of the principal section of the display device according to the first embodiment of the invention, particularly, a cross-sectional view taken along line Y-Y shown in FIG. 1;

FIG. 7 is a perspective view of another example of the display device according to the first embodiment of the invention;

FIG. 8 is a perspective view of another example of the display device according to the first embodiment of the invention;

FIG. 9 is a perspective view of a display device according to a second embodiment of the invention;

FIG. 10 is a perspective view of the display device according to the second embodiment of the invention;

FIG. 11 is a cross-sectional view of the principal section of the display device according to the second embodiment of the invention, particularly, a cross-sectional view taken along line X-X shown in FIG. 9;

FIG. 12 is an enlarged perspective view of the principal section of the display device according to the second embodiment of the invention;

FIG. 13 is a descriptive view for describing the display device according to the second embodiment of the invention;

FIG. 14 is a perspective view of another example of the display device according to the second embodiment of the invention;

FIG. 15 is a perspective view of a display device according to a third embodiment of the invention;

FIG. 16 is a perspective view of the display device according to the third embodiment of the invention;

FIG. 17 is an enlarged perspective view of the principal section of the display device according to the third embodiment of the invention;

FIG. 18 is a cross-sectional view of the principal section of the display device according to the third embodiment of the invention;

FIG. 19 is a cross-sectional view of the principal section of the display device of the third embodiment of the invention;

FIG. 20 is a cross-sectional view of the principal section of another example of the display device according to the third embodiment of the invention;

FIG. 21 is a view showing another example of the display device according to the third embodiment of the invention, wherein (a) is a perspective view of the principal section of the display device, (b) is a cross-sectional view of the principal section of the same, and (c) is a cross-sectional view of the principal section of the same;

FIG. 22 is a perspective view of still another example of the display device according to the third embodiment of the invention;

FIG. 23 is a perspective view of yet another example of the display device according to the third embodiment of the invention;

FIG. 24 is a perspective view showing another example of the display device of the invention;

FIG. 25 is a perspective view of still another example of the display device of the invention; and

FIG. 26 is a perspective view showing yet another example of the display device of the invention.

### BEST MODES FOR IMPLEMENTING THE INVENTION

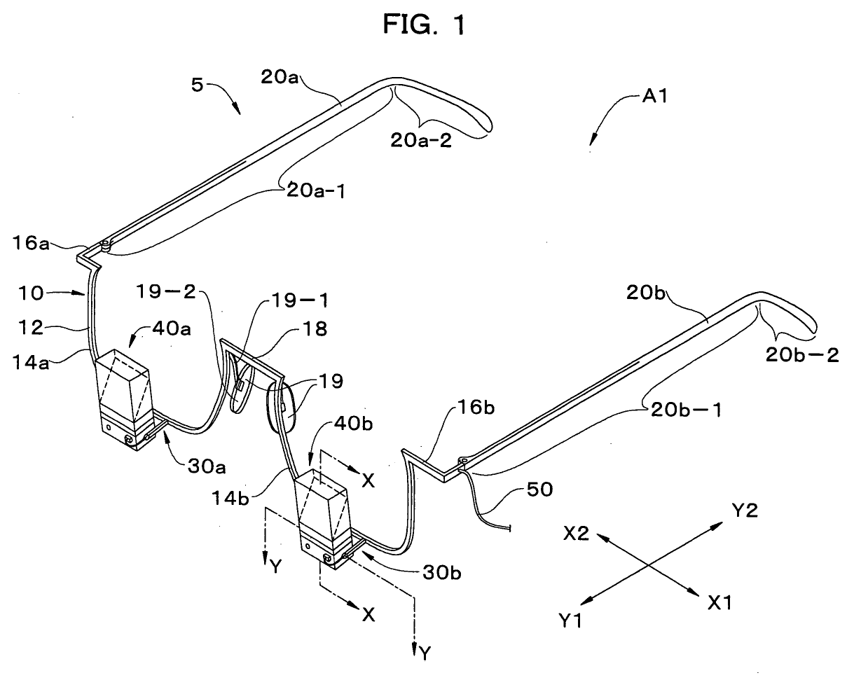

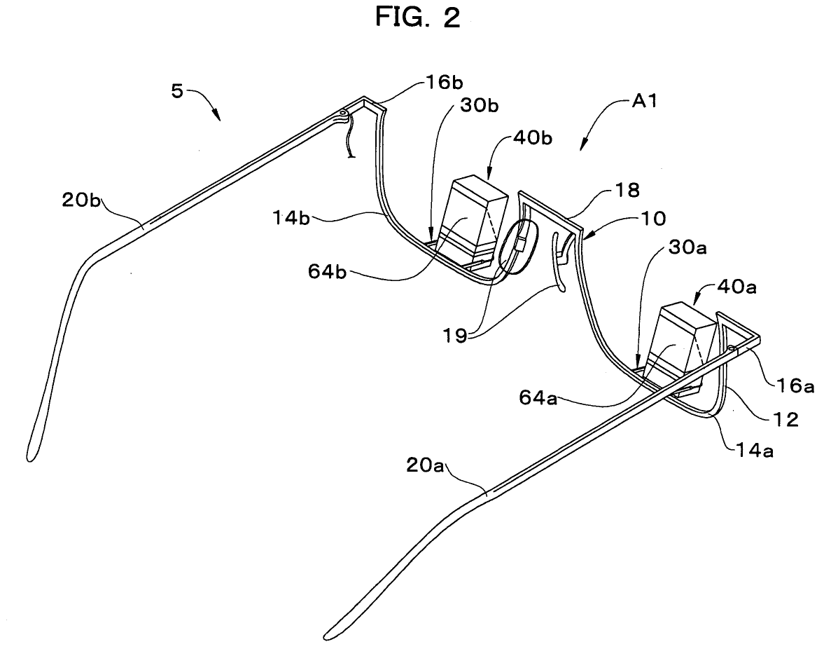

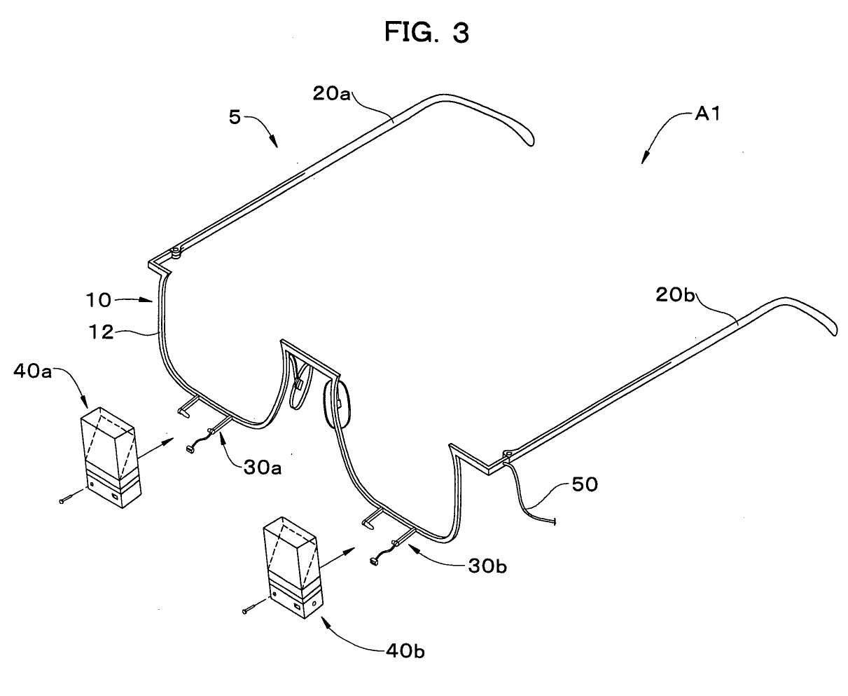

Preferred embodiments of the invention will be described hereinbelow by utilization of the drawings. As shown in FIGS. 1 through 3, a display device A1 according to the present invention has a main unit section 5 and two microdisplay units 40a, 40b.

Here, the main unit section 5 has a frame section 10 and support sections 30a, 30b. The main unit section 5 in its entirety assumes the shape of eyeglass frames. Specifically, the main unit section can be said to assume a shape formed by bending a thinly-elongated line/rod-like member.

The frame section 10 has a rim section 12, and temple sections 20a, 20b attached to the rim section 12. Here, the rim section 12 is a so-called front frame (may be called a rim) and comprises edge sections 14a, 14b; endpiece sections 16a, 16b; a bridge section 18; and nose pad sections 19.

The edge section 14a assumes a shape formed by bending a thinly-elongated rodlike member into an essentially U-shaped geometry and is assigned to the right eye. The edge section 14b also assumes a shape formed by bending a thinly-elongated rodlike member into an essentially U-shaped geometry and is assigned to the left eye.

The endpiece section 16a is a member provided so as to be continuously connected to the edge section 14a and assumes an essentially L-shaped geometry. The endpiece section 16b is a member provided so as to be continuously connected to the edge section 14b and assumes an essentially L-shaped geometry. The endpiece sections 16a, 16b constitute both end sections of the rim section 12.

The bridge section 18 is a member for connecting the end of the edge section 14a with the end of the edge section 14b and assumes a substantially rodlike shape. The nose pad sections 19 are attached to the respective edge sections of the rim section 12. Specifically, the nose pad sections 19 are provided at the respective edge sections 14a, 14b. The nose pad sections 19 are for supporting the rim section 12 upon contact with an upper portion of the nose and consist of a pair of pieces. Each nose pad section 19 has a support section 19-1 fixed to the rim section 12, and a flat-plate-like section 19-2 provided on the support section 19-1. The flat-plate-like section 19-2 comes into contact with the user's nose. The overall rim section 12 is formed essentially into a single piece.

The temple section 20a is a so-called “TSURU” and comprises a linearly-extending rodlike section 20a-1, and a bend section 20a-2 provided so as to be continuously connected to the rodlike section 20a-1. The temple section 20a is attached to the rim section 12 in a pivotable manner. Specifically, the temple section 20a is supported so as to be pivotable with respect to the endpiece section 16a of the rim section 12. Further, the temple section 20b comprises a linearly-extending rodlike section 20b-1, and a bend section 20b-2 provided so as to be continuously connected to the rodlike section 20b-1. The temple section 20b is attached to the rim section 12 in a pivotable manner. Specifically, the temple section 20b is supported so as to be pivotable with respect to the endpiece section 16b of the rim section 12. Pivotal movement of the temple sections 20a, 20b with respect to the rim section 12 is implemented by means of, e.g., a hinge mechanism or the like.

The support sections 30a, 30b will now be described. The support sections 30a, 30b are members for pivotably supporting the microdisplay units 40a, 40b and are provided at the lower ends of the respective edge sections of the rim section 12. Specifically, the support section 30a is provided at the lower end portion of the edge section 14a, and the support section 30b is provided at the lower end portion of the edge section 14b. The lower end portions of the edge sections 14a, 14b correspond to “downward portions which are located at positions downward of the eyes when the display device is mounted on the head.”

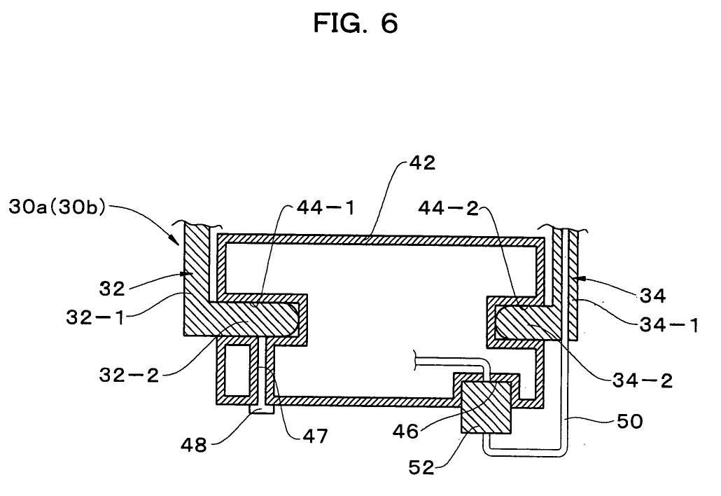

Since the support sections 30a, 30b are of similar structure, only the structure of the support section 30a will be described. As shown in FIG. 6, the support section 30a has a first latch section 32 and a second latch section 34. The first latch section 32 has a substantially-L-shaped cross-sectional profile and comprises a protuberant section 32-1 projecting from the edge section 14a, and a spindle section 32-2 projecting from the protuberant section 32-1 in a direction at substantially right angles thereto. The spindle section 32-2 is formed to assume a circular cross-sectional profile. Further, the second latch section 34 also has a substantially-L-shaped cross-sectional profile and comprises a protuberant section 34-1 projecting from the edge section 14a, and a spindle section 34-2 projecting from the protuberant section 34-1 in a direction at substantially right angles thereto. The spindle section 34-2 is formed to assume a circular cross-sectional profile. The spindle section 32-2 and the spindle section 34-2 are provided in line with each other so as to be mutually opposed.

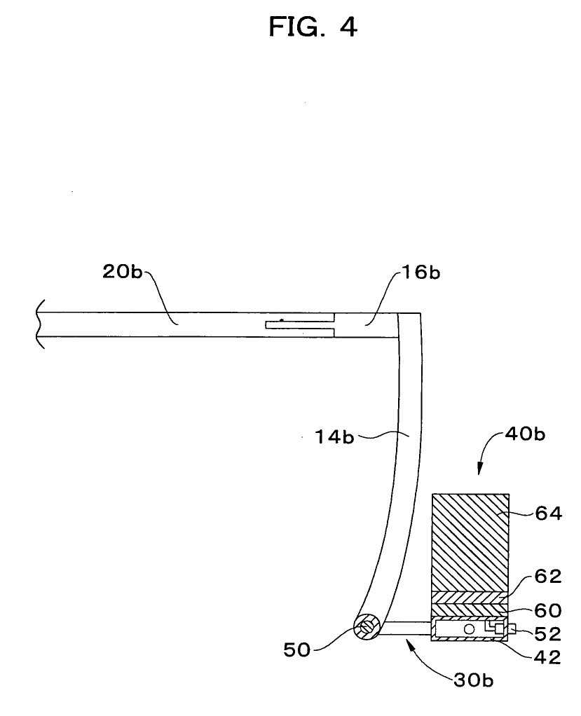

A harness 50 is exposed from the second latch section 34. The harness 50 has a power supply line to be used for supplying power to the microdisplay unit 40a, and a data transmit/receive line or the like for transmitting and receiving various types of data to and from the microdisplay unit 40a. The harness is drawn into an inlet hole formed in the endpiece section 16b of the rim section 12 and remains embedded in the rim section 12 until it is exposed from the second latch section 34 of the support section 30a (see FIG. 4). More specifically, the harness 50 introduced by way of the endpiece section 16b of the rim section 12 runs from the inside of the endpiece section 16b to the inside of the edge section 14b and further to the inside of the edge section 14a by way of the bridge section 18 and finally becomes exposed from the second latch section 34 of the support section 30a.

Since the support section 30b is identical in structure with the support section 30a, its detailed explanation is omitted. The harness 50 provided for the second latch section 34 of the support section 30b is also introduced by way of the endpiece section 16b, runs through the edge section 14b, and finally becomes exposed from the second latch section 34. The harness 50 exposed from the second latch section 34 is intended for use with the microdisplay unit 40b.

As mentioned above, the wires assigned to the respective microdisplay units 40a, 40b are introduced by way of the endpiece section 16b of the rim section 12, run through the inside of the rim section 12, and finally become exposed from the respective second latch sections of the corresponding support sections. Here, ends of the harnesses 50 exposed from the support sections 30a, 30b are equipped with connectors 52.

Materials to be used for constituting the frame section 10 and the support sections 30a, 30b are selected arbitrarily. However, the frame section 10 and the support sections 30a, 30b are formed from, e.g., metal. Alternatively, the frame section 10 and the support sections 30a, 30b may be constituted of synthetic resin.

Next, the microdisplay units (display sections) 40a, 40b will be described. The microdisplay unit 40a is supported by the support section 30a, and the microdisplay unit 40b is supported by the support section 30b. The microdisplay unit 40a is for use with the right eye, and the microdisplay unit 40b is for use with the left eye.

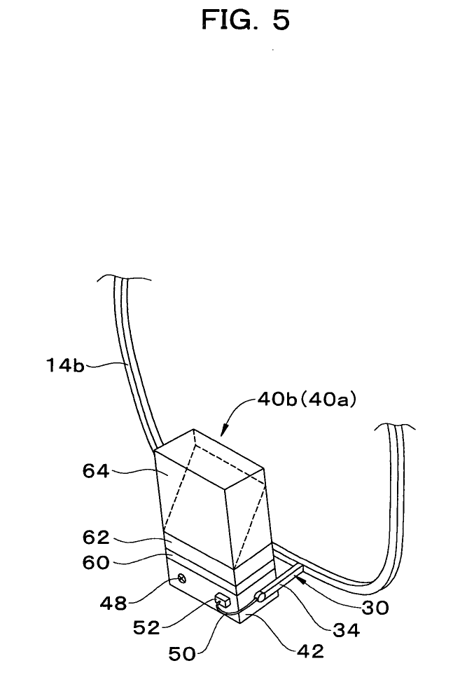

The microdisplay units 40a and 40b are of the same structure, and hence only the microdisplay unit 40b is described by way of example. As shown in FIGS. 4 and 5, the microdisplay unit 40b comprises an attachment main body section 42, a backlight 60, an LCD panel 62, and a reflection section 64. No special limitations are imposed on the shape and size of the microdisplay unit 40b. However, the overall microdisplay unit assumes an essentially rectangular parallelepiped shape and measures 15 mm to 40 mm in width, 20 mm to 45 mm in height, and 10 mm to 25 mm in depth.

Here, the attachment main body section 42 assumes an essentially rectangular parallelepiped shape and is rotatably supported by the support section 30a. Specifically, as shown in FIG. 6, the attachment main body section 42 has an insert hole 44-1 to be used for insertion of the spindle section 32-2 of the first latch section 32, and an insert hole 44-2 to be used for insertion of the spindle section 34-2 of the second latch section 34. By means of these holes, the microdisplay unit 40b is rotatable in relation to the support section 30b. Specifically, the microdisplay units 40a, 40b are rotatable around the axis extending in the lateral direction of the display device A1; that is, the axis extending in the direction X1-X2 (see FIG. 1).

By means of presence of adequate frictional resistance between the spindle section 32-2 and the insertion hole 44-1 and between the spindle section 34-2 and the insertion hole 44-2, the microdisplay unit 40b is manually rotated and fixed in relation to the support section 30b at a position where rotation of the microdisplay unit 40b has been stopped.

The attachment main body section 42 has a connection section 46 to be used for connection of the connector 52. The connection section 46 is connected to the backlight 60 and the LCD panel 62. A screw hole 47 is formed in the attachment main body section 42, thereby enabling insertion of a screw 48. The screw 48 is to be used for fixing the microdisplay unit 40b at a predetermined location. As a result of the screw 48 being pushed in a screwed manner, the leading end of the screw 48 comes into contact with the spindle section 32-2, thereby fixing the location of the microdisplay unit 40b in its rotating direction.

The backlight 60 is intended for irradiating light from a lower surface of the LCD panel 62. The backlight is formed from, e.g., an LED or the like. The backlight 60 is provided so as to be continuously connected to the attachment main body section 42. The LCD panel 62 is intended for outputting a display image. The LCD panel 62 is provided so as to be continuously connected to the backlight 60. The reflection section 64 is for enabling the user to view the display image output from the LCD panel 62 and has a mirror provided therein. By means of reflection of the display image output from the LCD panel 62 or a like action, the display image is displayed on a back surface 64a of the reflection section 63 so that the user can view the display image when peeping through the back surface 64a of the reflection section 64. A convex lens is provided on the part of the reflection section 64 at which the display image is output. The reflection section 64 is provided so as to be continuously connected to the LCD panel 62. The backlight 60, the LCD panel 62, and the reflection section 64 constitute a microdisplay.

The microdisplay unit 40a is identical in structure with the microdisplay unit 40b, and hence its detailed explanation is omitted.

The display device A1 is connected to an external information terminal (e.g., a portable terminal). The harness 50 drawn out of the display device A1 is connected to the information terminal, and transmission of data pertaining to the display image from the information terminal and supply of power are performed by way of the harness. Entry of information into the information terminal may be performed by way of input keys provided on the information terminal. Alternatively, a keyboard such as a collapsible keyboard may be prepared, to thereby enable entry of information by way of the keyboard. For instance, the collapsible keyboard may be set so as to be able to establish Bluetooth communication with the information terminal so that the data entered by way of the collapsible keyboard are transmitted to the information terminal.

An operating state of the display device A1 having the foregoing configuration will now be described. When in use, the display device A1 is mounted on the head as if eyeglasses were worn. Specifically, the display device is worn by fitting the temple sections 20a, 20b around the ears and bringing the nose pad sections 19 into contact with an upper portion of the nose. The microdisplay units 40a, 40b are attached to the lower ends of the respective edge sections 14a, 14b by way of the support sections 30a, 30b. Hence, the microdisplay units 40a, 40b are situated at positions diagonally downward of the user's eyes. The microdisplay units 40a, 40b are rotated so as to come to positions where a view is easily obtained. More specifically, the microdisplay unit 40a is rotated about the support section 30a until it comes to a position where a view is easily obtained. The microdisplay unit 40b is also rotated about the support section 30b until it comes to a position where a view is easily obtained. When the microdisplay units are firmly fastened to these positions, the screw 48 is tightly screwed.

Data pertaining to a display image are delivered from the external information terminal to which the harnesses 50 are connected, whereby the display image is output from the LCD panels 62. The thus-output display image is displayed on the reflection sections 64. Therefore, the user can visually ascertain the display image by means of staring at the reflection sections 64 of the microdisplay units 40a, 40b.

As mentioned above, the eyeglass-shaped main unit section 5 is equipped with the microdisplay units 40a, 40b, and hence the display device A1 of the embodiment enables reservation of a sufficient view for areas other than those acquired through the microdisplay units 40a, 40b, thereby enabling assuring a see-around effect. Namely, the microdisplay units 40a, 40b are provided at positions obliquely downward of user's front lines of sight, and hence the display device A1 of the embodiment enables assurance of a field of view in the forward, upward, and lateral directions with respect to the user's front lines of sight. Moreover, the microdisplay units 40a, 40b are disposed at positions obliquely downward with respect to the user's front lines of sight. Hence, there is also yielded an effect of images displayed on the microdisplay units 40a, 40b being easily viewable by the user.

The microdisplay units 40a, 40b are rotated about the support sections 30a, 30b and hence can be adjusted in a direction where the microdisplay units 40a, 40b are easily viewed.

Instead of having the foregoing configuration, the support sections 30a, 30b may be made vertically pivotable with respect to the rim section 12. Specifically, the support section 30a is constructed so as to pivot with respect to the edge section 14a, and the support section 30b is constructed so as to pivot with respect to the edge section 14b. As a result, vertical positions of the microdisplay units can be adjusted.

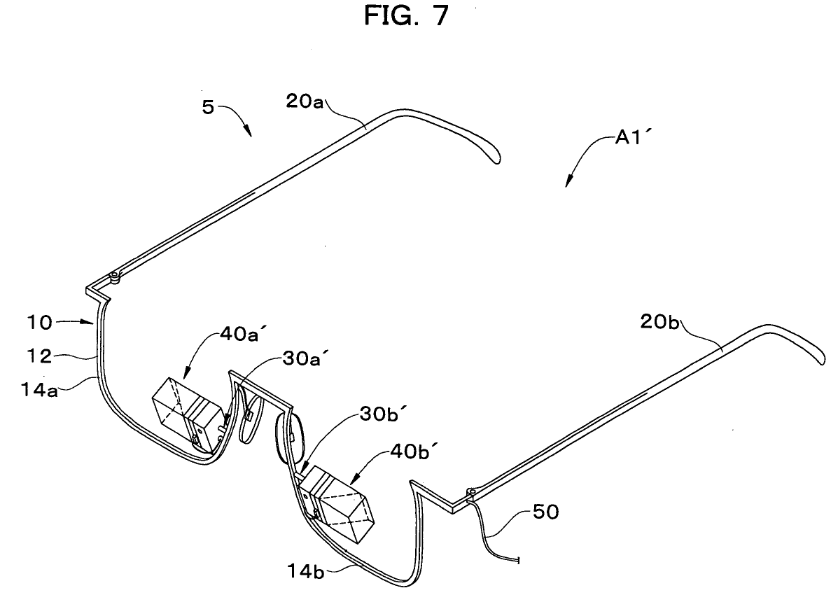

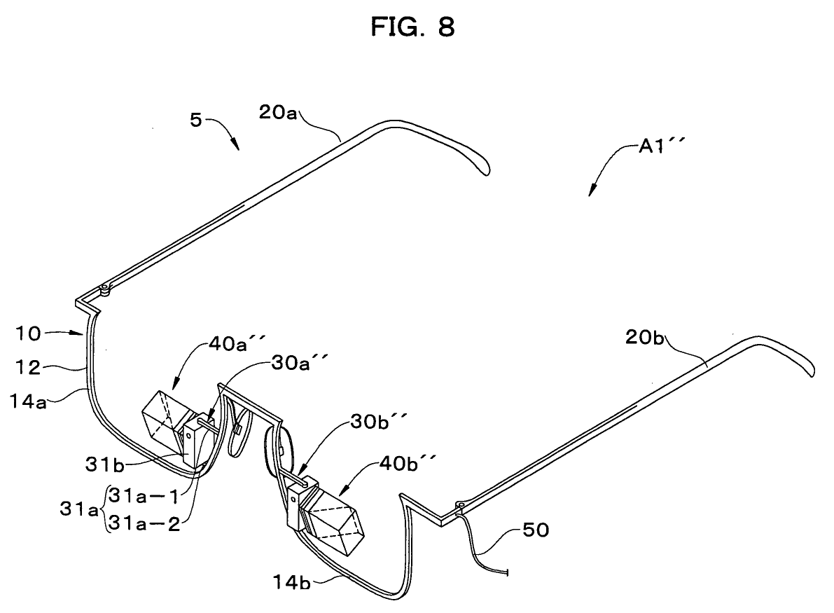

The first embodiment has been described under the assumption that the microdisplay units 40a, 40b are provided at the lower ends of the edge sections 14a, 14b. However, the microdisplay units may be provided on lateral portions of the edge sections. Namely, the microdisplay units are configured into a horizontally-oriented type. More specifically, the microdisplay units are configured as shown in FIGS. 7 and 8.

In an example of a display device A1′ shown in FIG. 7, a support section 30a′ is provided on a lateral portion of the edge section 14a. A microdisplay unit 40a′ is attached to the support section 30a′. Moreover, a support section 30b′ is provided on a lateral portion of the edge section 14b, and a microdisplay unit 40b′ is attached to the support section 30b′.

The microdisplay unit 40a′ is identical in configuration with the microdisplay unit 40a. Further, the microdisplay unit 40b′ is identical in configuration with the microdisplay unit 40b. Hence, their detailed explanations are omitted.

In an example of a display device A1″ shown in FIG. 8, a support section 30a″ is provided on a lateral portion of the edge section 14a, and a microdisplay unit 40a″ is rotatably attached to the support section 30a″. A support section 30b″ is provided on a lateral portion of the edge section 14b, and a microdisplay unit 40b″ is rotatably attached to the support section 30b″.

The support sections 30a″ and 30b″ are identical in configuration with each other, except that they are bilaterally symmetrical. The support section 30a″ is now described. In the support section 30a″, a first support section 31a consisting of a first latch section 31a-1 and a second latch section 31a-2 is attached to a lateral portion of the edge section 14a. The first and second latch sections 31a-1 and 31a-2 are constructed in the same manner as are the first and second latch sections 32, 34 of the first embodiment. The second support section 31b is supported on the first support section 31a so as to be rotatable with respect to the first support section 31a. Specifically, the second support section 31b is rotatable about the vertical axis. The microdisplay unit 40a″ is axially supported on the second support section 31b. More specifically, the microdisplay unit 40a″ is supported so as to be rotatable about the lateral axis of the display device A1″.

The support section 30b″ is identical in structure with the support section 30a″, and hence its explanation is omitted. The microdisplay unit 40b″ is supported so as to be rotatable with respect to the second support section of the support section 30b″. Specifically, the microdisplay unit 40b″ is also supported so as to be rotatable about the lateral axis of the display device A1″.

The microdisplay unit 40a″ is identical in configuration with the microdisplay unit 40a, and the microdisplay unit 40b″ is identical in configuration with the microdisplay unit 40b, and hence their detailed explanations are omitted.

Here, the lateral portions of the display devices A1′ and A1″ correspond to “inner portions which are situated at positions within an area between the eyes when the display device is mounted on the head.”

As shown in FIGS. 7 and 8, when the display device is constructed as a horizontally-oriented type, the user's field of view can be broadened to a much greater extent. Accordingly, the user can acquire a sufficient see-around effect. Specifically, the support sections provided on the inner portions obstruct the left field of view of the user's right eye. However, the left field of view is observed with the left eye. Obstruction of the right eye from observing the left field of view does not pose any substantial problem. Similarly, the rightward field of view of the user's left is obstructed, but the rightward field of view is observed with the right eye. Hence, obstruction of the left eye from observing the right field of view does not pose any substantial problem. As mentioned above, the user can obtain a sufficient see-around effect.

In the first embodiment, the microdisplay units are provided on the rim section 12 by way of the support sections. However, the microdisplay units may be provided directly on the rim section 12 without involvement of the support sections.

Next, a second embodiment will be described. In a display device A2 of the second embodiment, the microdisplay units are provided so as to be oriented laterally with respect to the center of the rim section, and positions of the microdisplay units can be adjusted in a rotating direction centered on the lateral direction as well as in a vertical direction.

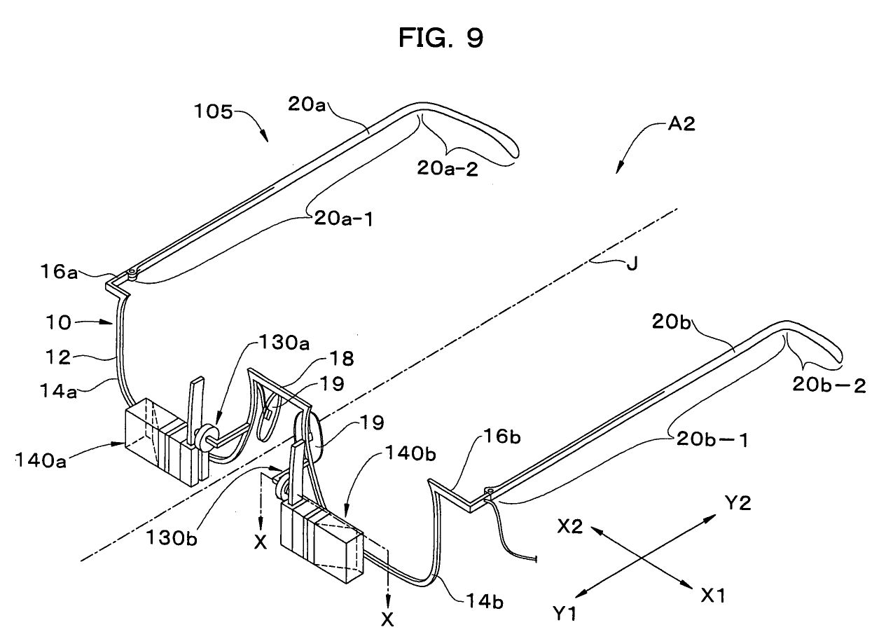

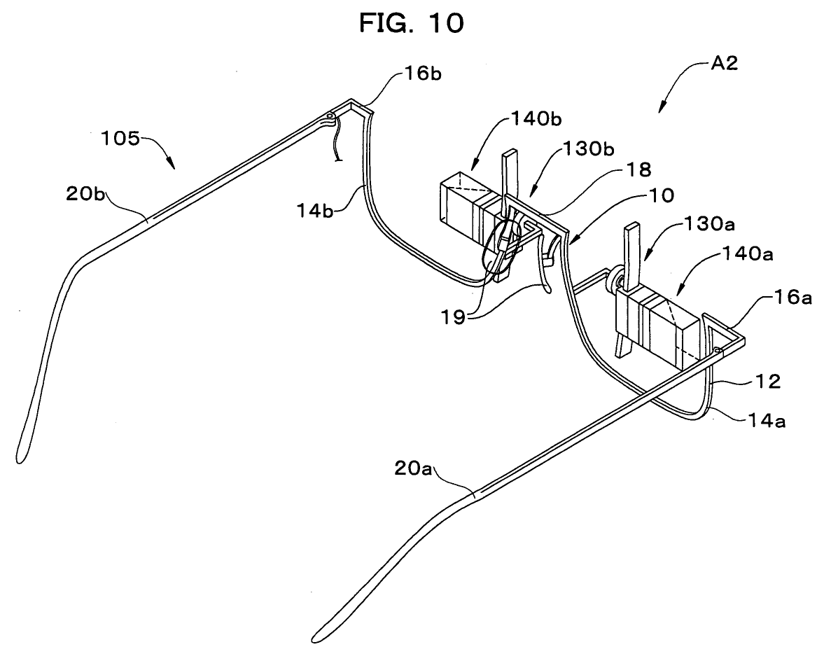

As shown in FIGS. 9, 10, 11, and 12, the display device A2 has a main unit section 105, and two microdisplay units 140a, 140b.

Here, the main unit section 105 has the frame section 10 and support sections 130a, 130b.

The frame section 10 of the embodiment is identical in configuration with the frame section employed in the first embodiment. Specifically, the frame section 10 has the rim section 12, and the temple sections 20a, 20b attached to the rim section 12. Here, the rim section 12 comprises the edge sections 14a, 14b; the endpiece sections 16a, 16b; the bridge section 18; and the nose pad sections 19. Detailed explanations of these sections have already been provided in the first embodiment, and hence repeated explanations are omitted.

Here, the frame section 10 is formed from metal or synthetic resin, as in the case of the first embodiment.

The support sections 130a, 130b will now be described. Here, the support sections 130a, 130b are constructed so as to be horizontally symmetrical with respect to the center position of the rim section 12; i.e., the center position of the display device A2. Hence, the support section 130b will now be described by way of example.

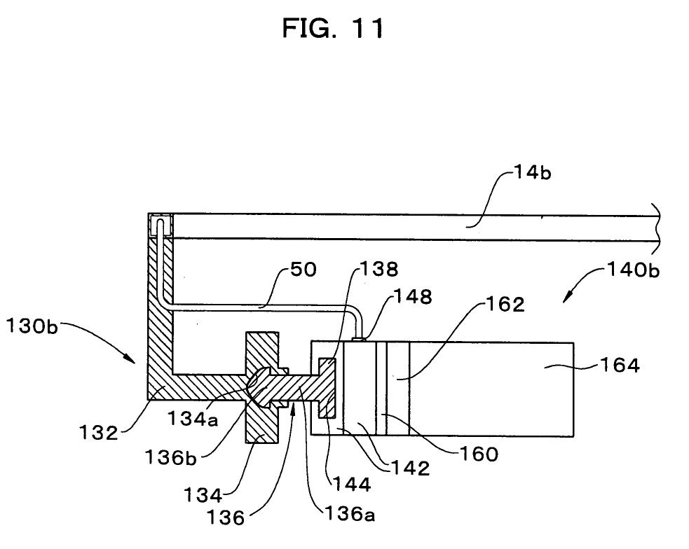

As shown in FIG. 11, the support section 130b has a base section 132, a bearing section 134, a spindle section 136, and a rail section 138. Here, the base section 132 has a shape formed by bending a rodlike member into an essentially L-shaped geometry. The leading edge of the base section 132 is oriented in a lateral direction of the display device A2 (i.e., an X1 direction in FIG. 9).

The harness 50 is exposed from the base section 132. The harness 50 has a power supply line to be used for supplying power to the microdisplay unit 140a, and a data transmit/receive line or the like for transmitting and receiving various types of data to and from the microdisplay unit 140a. As in the case of the first embodiment, the harness is drawn into the inlet hole formed in the endpiece section 16b of the rim section 12 and remains embedded in the rim section 12 until it is exposed from the base section 132 of the support section 130b. More specifically, the harness 50 introduced by way of the endpiece section 16b of the rim section 12 runs from the inside of the endpiece section 16b to the inside of the edge section 14b and finally becomes exposed from the base section 132.

The bearing section 134 is fixed to the extremity of the base section 312 and has a bearing hole 134a to be used for insertion and rotatable support of the spindle section 136. The bearing hole 134a is formed so as to match the shape of the spindle section 136 and assumes a circular cross-sectional profile. The space located deeper in the bearing hole 134a is of larger diameter than the space located less deep in the bearing hole 134a. The base section 132 and the bearing section 134 are formed from, e.g., synthetic resin. The base section 132 and the bearing section 134 are formed into a single piece. The base section 132 and the bearing section 134 may be constituted separately from each other and bonded together by means of an adhesive or the like.

The spindle section 136 is a shaft member having a circular cross-sectional profile and has a main body section 136a and a protuberant section 136b. The protuberant section 136b is larger in diameter than the main body section 136a. As a result, the spindle section 136 is supported so as to be rotatable with respect to the bearing section 134 while being attached to the bearing section 134. The direction in which the spindle section is to rotate is a direction centered on the axis of the spindle section 136, and the axis of the spindle section 136 is oriented in the direction X1-X2. The spindle section 136 is formed from, e.g., synthetic resin. The leading end of the spindle section 136 is formed so as to have a large diameter. Hence, the spindle section 136 is prevented from being readily dislodged from the bearing section 134. When attached to the bearing section 134, the spindle section 136 can be attached to the bearing section 134 by means of pushing action. In a state in which the spindle section 136 remains held in the bearing section 134, the spindle section 136 and the bearing section 134 are constructed such that given frictional resistance exists between them. When the spindle section 136 is rotated with respect to the bearing section 134 and is stopped at a certain position, the spindle section 136 is fixed at that position.

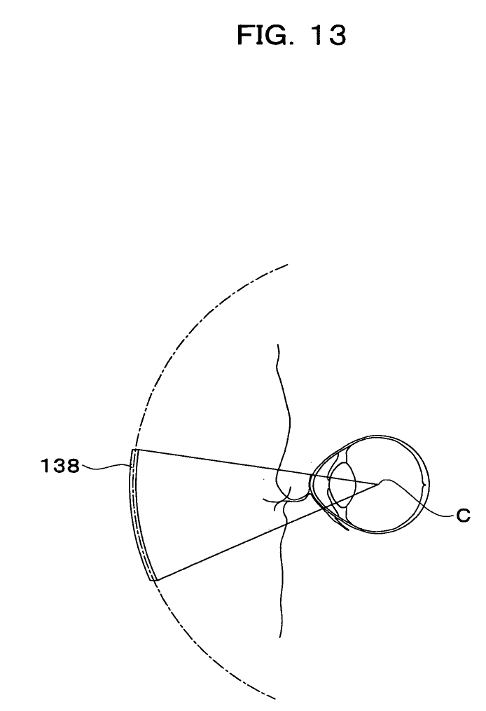

The rail section 138 assumes the shape of a flat rod, and a substantial center of the rail section is fastened to the spindle section 136. This rail section 138 acts as a rail for causing the microdisplay unit 140b to perform sliding action. The rail section 138 is made of, e.g., synthetic resin. Although the spindle section 136 and the rail section 138 are formed into a single piece, they may be formed by fixing separate pieces together. When viewed in a lateral direction, the rail section 138 is curved slightly. As shown in FIG. 13, the rail section 138 is constructed so as to be situated along a circle centered around the center of rotation C (may be called the rotational center) of the eyeballs of the user who wears the display device A2. For instance, the rail section is constructed so as to be situated along such a circle having a radius of 20 mm to 45 mm. The rail section 138 is formed to assume the curvature radius from 20 mm t 45 mm when viewed from the side. Specifically, the rail section 138 can be said to have a circular-arc travel path.

The rail section 138 and the spindle section 136 can be said to constitute the above-described sliding path section.

The support section 130a is identical in structure with the support section 130b, except that they are bilaterally symmetrical, and hence detailed explanation of the support section 130a is omitted. Specifically, the support sections are symmetrical with respect to a vertical plane passing through an axis J of the display device A2 (see FIG. 9). Even in relation to another explanation, unless otherwise specified, the horizontal symmetry has the same meaning. The harness 50 exposed from the base section 132 of the support section 130a is introduced into the endpiece section 16b, runs to the edge section 14a by way of the edge section 14b and the bridge section 18, and finally becomes exposed from the base section 132 of the support section 130a.

As mentioned above, the wires assigned to the microdisplay units 140a, 140b are introduced from the endpiece section 16b of the rim section 12, run through the inside of the rim section 12, and become exposed from the base sections of the corresponding support sections. The ends of the harnesses 50 exposed from the support sections 130a, 130b are equipped with connectors 148 (see FIG. 11).

Although the support sections 130a, 130b are described as being formed from synthetic resin, the support sections may be formed from metal.

The microdisplay units (display sections) 140a, 140b will now be described. The microdisplay unit 140a is supported by the support section 130a, and the microdisplay unit 140b is supported by the support section 130b. Namely, the microdisplay unit 140a is for use with the right eye, and the microdisplay unit 140b is for use with the left eye.

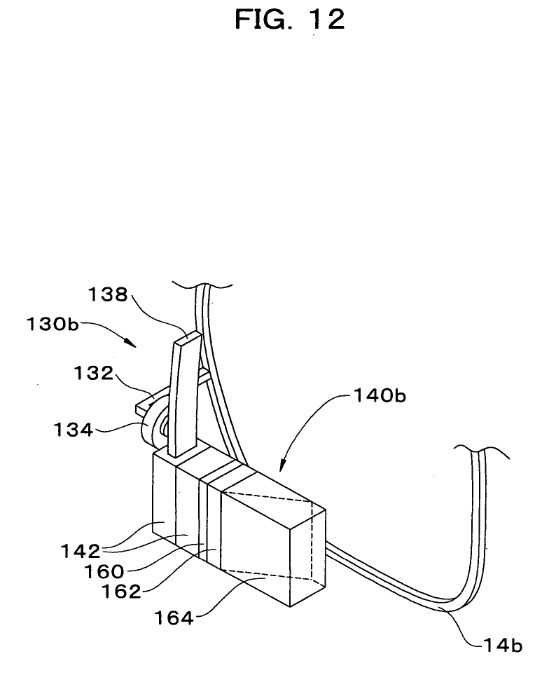

The microdisplay units 140a, 140b are of identical structure, except that they are bilaterally symmetrical. The microdisplay unit 140b is described by way of example. As shown in FIG. 12, the microdisplay unit 140b has a mount main body section 142, a backlight 160, an LCD panel 162, and a reflection section 164.

Here, the attachment main body section 142 assumes the shape of a substantially-rectangular parallelepiped case and is constructed so as to be slidable over the rail section 138. The attachment main body section has a structural portion having a C-shaped cross-sectional profile, and a groove section 144 having a convex-shaped cross-sectional profile is provided in the structural portion. The groove section 144 and the rail section 138 have constant frictional resistance, and frictional resistance is present such that a certain degree of force is required to slide the attachment main body section 142 over the rail section 138. The attachment main body section 142 is provided with a connection section to be used for establish connection with the connector 148. As in the case of the first embodiment, a screw hole to be used for insertion of a screw may be formed, and the tip end of the screw brought into contact with the rail section 138, thereby fixing the microdisplay unit 140b to the rail section 138.

The backlight 160, the LCD panel 162, and the reflection section 164 are constructed in the same manner as are the corresponding sections in the first embodiment, and hence their detailed explanations are omitted. Specifically, the backlight 160 is identical in structure with the backlight 60 and is provided so as to be continuously connected to the attachment main body section 142. The LCD panel 162 is identical in structure with the LCD panel 62 and is provided so as to be continuously connected to the backlight 160. The reflection section 164 is identical in structure with the reflection section 64 and is provided so as to be continuously connected to the LCD panel 162. The backlight 160, the LCD panel 162, and the reflection section 164 constitute the microdisplay.

The microdisplay units 140a, 140b are identical in structure, except that they are bilaterally symmetrical, and hence repeated explanations are omitted. The microdisplay unit 140a is slidably provided on the rail section 138 laid in the support section 130a.

As in the case of the first embodiment, the display device A2 is also connected to an external information terminal (e.g., a portable terminal). Specifically, the harness 50 drawn out of the display device A2 is connected to the information terminal, and transmission of data pertaining to a display image from the information terminal and power supply are performed by way of the harness. Entry of information into the information terminal may be performed by way of input keys provided on the information terminal. Alternatively, a keyboard such as a collapsible keyboard may be prepared, to thereby enable entry of information by way of the keyboard. For instance, the collapsible keyboard may be set so as to be able to establish Bluetooth communication with the information terminal so that the data entered by way of the collapsible keyboard are transmitted to the information terminal.

The lengths of the microdisplay units 140a, 140b may be arranged so as to be able to extend and contract, thereby adjusting the lateral positions of the reflection section. For instance, the attachment main body section 142 may be separated from other constituent elements (hereinafter called “microdisplay main units”); that is, the backlight 160, the LCD panel 162, and the reflection section 164. The attachment main body section 142 is formed into a cylindrical shape, and the microdisplay main unit is arranged so as to be able to extend and contract with respect to the attachment main body section 142.

The operating state of the display device A2 having the foregoing configuration will now be described. As in the case of the first embodiment, when in use, the display device A2 is mounted on the head as if eyeglasses were worn. Specifically, the display device is worn by fitting the temple sections 20a, 20b around the ears and bringing the nose pad sections 19 into contact with an upper portion of the nose.

At that time, the microdisplay units 140a, 140b are vertically slidable with respect to the rail section 138 (strictly speaking, slidable in a traveling direction including vertical components), and the spindle section 136 fixed to the rail section 138 is rotatable with respect to the bearing section 134. The positions of the microdisplay units 140a, 140b can be adjusted in the vertical direction (strictly speaking, a direction in line with the rail section 138) and in the rotational direction centered on the lateral direction of the display device A2. The user can adjust the reflection sections 164 of the microdisplay units 140a, 140 so as to move the same to appropriate positions.

Data pertaining to a display image are delivered from the external information terminal to which the harness 50 is connected, and the display image is output from the LCD panel 162. The thus-output display image is displayed on the reflection section 164. The user can visually ascertain the display image by means of staring at the reflection sections 164 of the microdisplay units 140a, 140b.

As mentioned above, the eyeglass-shaped main unit section 105 is equipped with the microdisplay units 140a, 140b, and hence the display device A2 of the embodiment enables reservation of a sufficient view for areas other than those acquired through the microdisplay units 140a, 140b, thereby assuring a see-around effect. Namely, in the display device A2 of the embodiment, the vertical directions and rotational directions of the microdisplay units 140a, 140b can be adjusted. If the user adjusts the microdisplay units 140a, 140b to predetermined positions, a field of view can be ensured in a direction other than the direction in which the user visually ascertains the reflection sections 164 of the microdisplay units 140a, 140b.

More specifically, in relation to the user's right eye, the field of view in the direction of the line of sight in which the user visually ascertains the microdisplay units 140a is interrupted. The microdisplay unit 140a is attached to the support section 130a provided at the center of the rim section 12. Hence, the leftward field view of the user's right eye is also interrupted. However, the leftward field of view of the human right eye is originally narrow, and the leftward field of view is ascertained by the left eye. Hence, interruption of the leftward field view of the right eye does not pose any substantial problem.

In relation to the user's left eye, the field of view in the direction of the line of sight in which the user visually ascertains the microdisplay units 140b is interrupted. The microdisplay unit 140b is attached to the support section 130b disposed at the center of the rim section 12. Hence, the rightward field of view of the user's left eye is also interrupted. However, the rightward field of view of the human left eye is originally narrow, and the rightward field of view is ascertained by the right eye. Hence, interruption of the rightward field view of the left eye does not pose any substantial problem.

As mentioned above, the microdisplay units 140a, 140b can be adjusted in both vertical and rotational directions. Hence, the user can adjust the positions of the microdisplay units 140a, 140b to positions where the user can easily view a display image.

In the first and second embodiments, the length of the bridge section 18 of the rim section 12 may be made so as to be extendable and contractible. For example, like the structure of an antenna, two rod-shaped sections having different diameters are made so as to be able to overlap, to thereby enabling extension and contraction. By means of such a structure, the lateral positions of the microdisplay units can be adjusted.

In relation to the foregoing structure, the spindle section 136 has been described as being rotatable with respect to the bearing section 134. A joint between the spindle section 136 and the bearing section 134 may be embodied by means of a universal joint. Rotation of the spindle section 136 as a unit as well as rotation of the spindle section 136 about the axis thereof are made feasible. By means of such a configuration, orientation of the microdisplay units can also be adjusted.

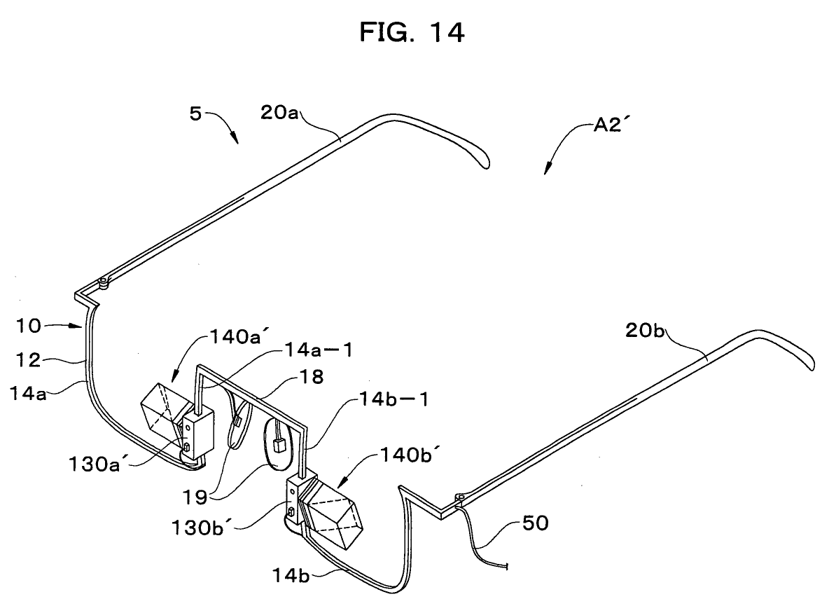

The display device may also be imparted with a configuration, such as that shown in FIG. 14, as a modification of the second embodiment. Specifically, a slidable path is formed in the edge sections of the rim section 12 of a display device A2′.

The microdisplay units are attached to an interior section 14a-1 constituting an interior of the edge section 14a and an interior section 14b-1 constituting an interior of the edge section 14b by way of the support sections, respectively. The support sections are slidable over the interior sections.

The edge section 14a is identical in structure with the edge section 14b, except that they are bilaterally symmetrical. The structure of the edge section 14a will be described by way of example. The support section 130a′ is slidably attached to the interior section 14a-1 of the edge section 14a. Like the rail section 138, the interior section 14a-1 is slightly curved when viewed in a lateral direction. Specifically, the interior section 14a-1 is configured to situate along a circle centered on the center of rotation C (may be called the rotational center) of the eyeballs of the user who wears the display device A2′. For instance, the interior section is constructed so as to be situated on such a circular arc having a radius of 20 mm to 45 mm (preferably 30 mm). Specifically, the interior section 14a-1 is formed so as to have a curvature radius of 20 mm to 45 mm when viewed laterally. More specifically, the interior section 14a-1 can be said to have a circular-arc-shaped travel path.

The support section 130a′ supports the microdisplay unit 140a′ in a rotatable manner. Namely, the support section 130a′ has an unillustrated bearing section and supports a spindle section provided on the microdisplay unit 140a′. As a result, the microdisplay unit 140a′ can be rotated about the lateral axis of the display device A2′.

In other words, the microdisplay unit 140a′ is susceptible to adjustment in a rotational direction centered on the lateral axis of the display device, as well as adjustment in the vertical direction.

The edge section 14b has a similar structure. The microdisplay unit 140b′ is susceptible to adjustment in a rotational direction centered on the lateral axis of the display device, as well as adjustment in the vertical direction.

As a result of the display device being constructed in such a manner as shown in FIG. 14, the structure of the rim section 12 can be utilized as a slide path.

In the example shown in FIG. 14, the support sections supporting the microdisplay units can be slid along the edge sections. However, the microdisplay units per se may be made slidable along the edge sections.

A third embodiment will now be described. In a display device A3 of this embodiment, microdisplay units are supported by support sections which pivot about predetermined points on the temple sections of the frame sections.

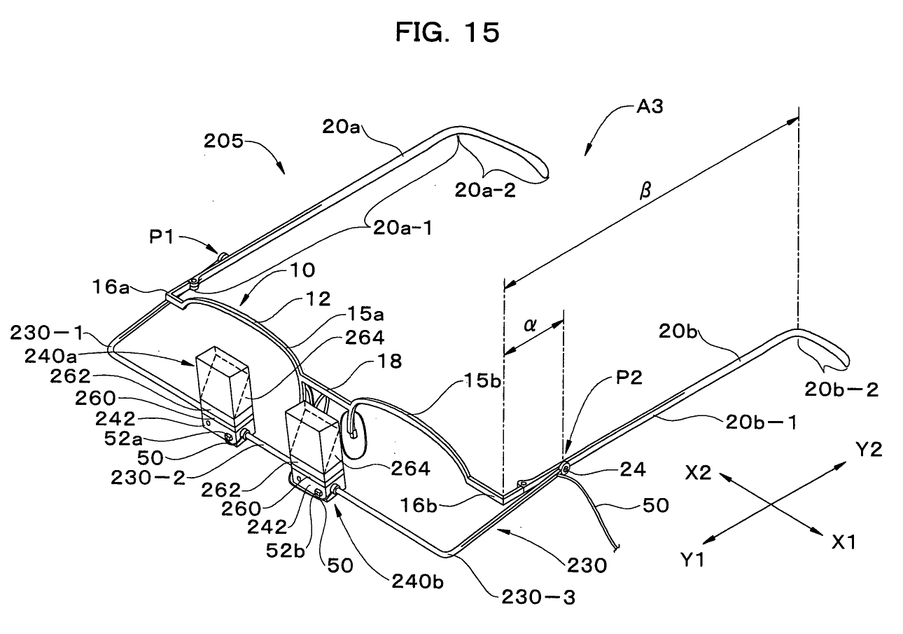

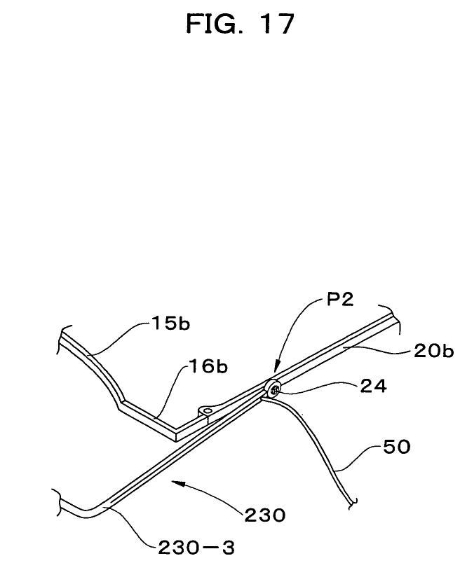

Specifically, as shown in FIGS. 15 to 19, the display device A3 has a main body section 205 and two microdisplay units 240a, 240b.

The main body section 205 has the frame section 10 and support sections 230.

The frame section 10 of the embodiment has the rim section 12, and temple sections 20a, 20b attached to the rim section 12. Here, the rim section 12 has the edge sections 15a, 15b; the endpiece sections 16a, 16b; the bridge section 18; and the nose pad sections 19.

The edge section 15a has a shape formed by bending upward an elongated, narrow rodlike member. The edge section 15a is assigned to the right eye. The edge section 15b also has a shape formed by bending upward an elongated, narrow rodlike member, and the edge section 15b is assigned to the left eye.

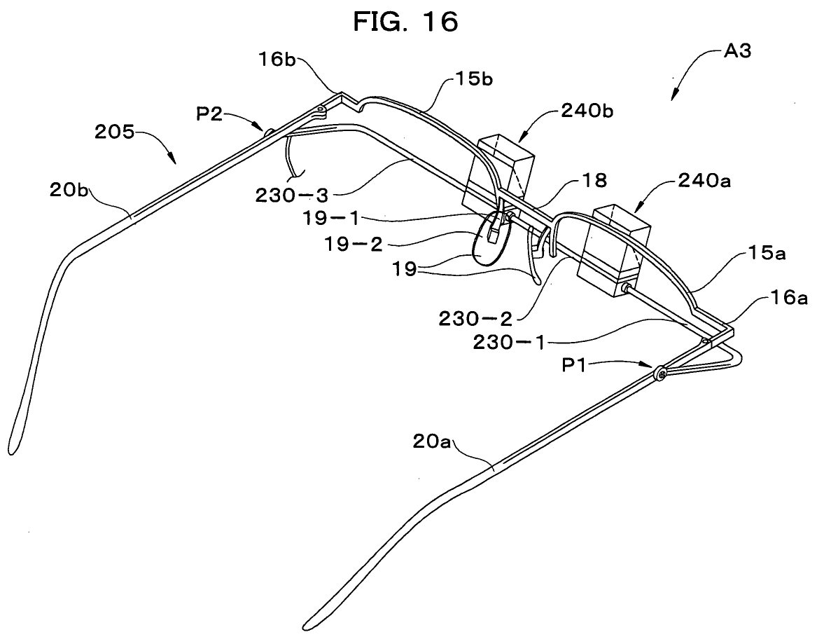

The endpiece section 16a is a member that is continuously connected to the edge section 15a and has a substantially L-shaped geometry. The endpiece section 16b is a member that is continuously connected to the edge section 15b and has a substantially L-shaped geometry. The bridge section 18 is a member for connecting the end of the edge section 15a with the end of the edge section 15b and has a substantially rodlike shape. The nose pad sections 19 are provided on the edge sections of the rim section 12. Specifically, the nose pad sections 19 are provided on the edge sections 15a and 15b, respectively. The nose pad sections 19 are for supporting the rim section 12 upon contact with an upper portion of the nose. A pair of nose pad sections 19 are provided. Each nose pad section 19 comprises the support section 19-1 fixed to the rim section 12, and a flat-plate-like section 19-2 provided on the support section 19-1 (see FIG. 16). The flat-plate-like section 19-2 comes into contact with the user's nose. The overall rim section 12 is formed essentially into a single piece.

The temple section 20a comprises the linearly-extending rodlike section 20a-1 and the bend section 20a-2 provided so as to be continuously connected to the rodlike section 20a-1. The temple section 20a is attached to the rim section 12 in a pivotable manner. Specifically, the temple section 20a is supported so as to be pivotable with respect to the endpiece section 16a of the rim section 12. Further, the temple section 20b comprises the linearly-extending rodlike section 20b-1, and the bend section 20b-2 provided so as to be continuously connected to the rodlike section 20b-1. The temple section 20b is attached to the rim section 12 in a pivotable manner. Specifically, the temple section 20b is supported so as to be pivotable with respect to the endpiece section 16b of the rim section 12.

The support section 230 will now be described. The support section 230 of the embodiment comprises an L-shaped member (first L-shaped member) 230-1, a rodlike member 230-2, and an L-shaped member (second L-shaped member) 230-3.

The entire L-shaped member 230-1 assumes an elongated narrow L-shaped geometry which is formed by bending an elongated, narrow rodlike member into an L-shaped form. One end of the L-shaped member 230-1 is supported so as to be pivotal about a predetermined location P1 on the temple section 20a. The structure in which the L-shaped member 230-1 is attached to the temple section 20a is identical with that of the L-shaped member 230-3 to be described later, and hence its detailed explanation is omitted. One end of the L-shaped member 230-1 is inserted into an attachment main body section 242 of the microdisplay unit 240a.

The rodlike member 230-2 assumes the shape of a rod, and one end of the rodlike member 230-2 is inserted into the attachment main body section 242 of the microdisplay unit 240a. The other end of the rodlike member 230-2 is inserted into an attachment main body section 242 of the microdisplay unit 240b.

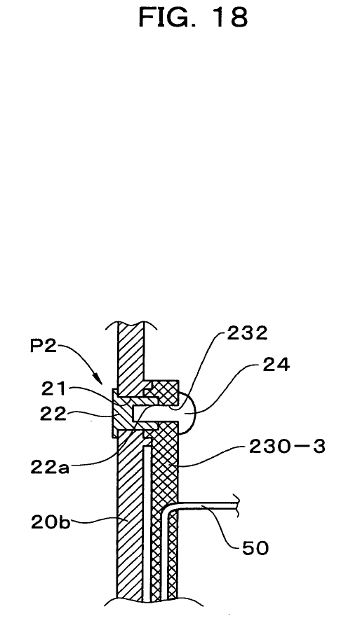

The entire L-shaped member 230-3 assumes an elongated, narrow L-shaped geometry which is formed by bending an elongated, narrow rodlike member into an L-shaped form. Specifically, the L-shaped member 230-3 assumes a shape which is bilaterally symmetrical with respect to the L-shaped member 230-1. One end of the L-shaped member 230-3 is supported so as to be pivotal about a predetermined location P2 on the temple section 20b. Specifically, as shown in FIG. 18, an insert hole 21 is formed in the temple section 20b for fixing an attachment section 22 having a screw hole 22a, and the attachment section 22 is fixedly inserted into the insert hole 21. An insert hole 232 is formed in the end of the L-shaped member 230-3, and a screw 24 is inserted into the insert hole 232 and secured to the attachment section 22. As a result, the L-shaped member 230-3 can be pivoted with respect to the temple section 20b by means of loosely fastening the screw 24. The L-shaped member 230-3 is fixed to the temple section 20b by means of tightly fastening the screw 24. When removal of the L-shaped member 230-3 from the temple section 20b is desired, the only requirement is to remove the screw 24 from the attachment section 22.

The position of the predetermined point P2 is defined so as to be situated beside the center of rotation (maybe called the rotational center) of the user's eyeballs when the user has worn the display device A3. Specifically, the axis of the center of rotation of the L-shaped member 230-3 runs through the center of rotation of the eyeballs. For instance, the position of the predetermined point P2 is situated at a position away from the corner of the endpiece 16b by 20 mm to 45 mm. Specifically, in FIG. 15, a distance a is 20 mm to 45 mm. When the temple section 20b is perceived as separate members; that is, the linearly-extending rodlike section 20b-1 and the bend section 20b-2 provided so as to be continuously connected to the rodlike section 20b-1, the ratio of the distance α to the distance β between the end of the endpiece section 16b and the end of the rodlike section 20b-1 may be set to 2 to 4.5:11. In short, α/β is set to the range from 0.18 to 0.41.

The structure in which the L-shaped member 230-1 is attached to the temple section 20a also becomes bilaterally symmetrical in the same manner as mentioned previously. Specifically, one end of the L-shaped member 230-1 is supported so as to be pivotal about the predetermined position P1 on the temple section 20a. The predetermined point P1 is also defined so as to be situated beside the center of rotation (maybe called the rotational center) of the user's eyeballs when the user has worn the display device A3. Specifically, the axis of the center of rotation of the L-shaped member 230-1 runs through the center of rotation of the eyeballs.

The lateral portion of the L-shaped member 230-1, the rodlike member 230-2, and the lateral portion of the L-shaped member 230-3 are provided in line with each other.

The harness 50 is inserted into the support section 230. The harness 50 has a power supply line for supplying power to the microdisplay unit 240a, and a data transmit/receive line for transmitting or receiving various types of data to and from the microdisplay unit 240a. The harness 50 is introduced into the L-shaped member 230-3 from the end thereof close to the position—where the L-shaped member is connected to the temple section 20b—and drawn out, or exposed, from a neighborhood of the microdisplay unit 240b of the L-shaped member 230-3. The thus-exposed harness 50 is connected to a connector 52b and introduced into the rodlike member 230-2. The harness 50 introduced into the rodlike member 230-2 is again drawn out and connected to a connector 52a.

The microdisplay units 240a, 240b will now be described. The microdisplay units 240a, 240b are supported by the support section 230. The microdisplay unit 240a is for use with the right eye, and the microdisplay unit 240b is for use with the left eye.

The microdisplay units 240a, 240b are of identical structure. The microdisplay unit 240a is described by way of example. The microdisplay unit 240a comprises the attachment main body section 242, a backlight 260, an LCD panel 262, and a reflection section 264.

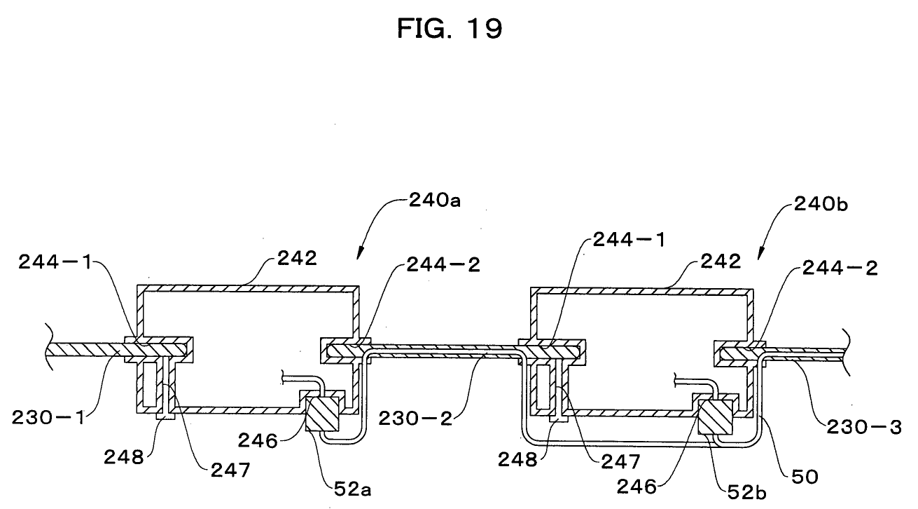

The attachment main body section 242 has the shape of an essentially-rectangular parallelepiped case and is supported by the support section 230 so as to be rotatable. As shown in FIG. 19, the attachment main body section 242 has an insertion hole 244-1 to be used for inserting the L-shaped member 230-1, and an insertion hole 244-2 to be used for inserting the rodlike member 230-2. The microdisplay unit 240a is rotatable with respect to the support section 230. Appropriate frictional resistance exists between the L-shaped member 230-1 and the insertion hole 244-1 and between the rodlike member 230-2 and the insertion hole 244-2. The microdisplay unit 240a is manually rotated, and the microdisplay unit 240a is secured to the support section 230 at the position where the rotation of the microdisplay unit has been stopped.

The attachment main body section 242 has a connection section 246 for use in connection with the connector 52a. The connection section 246 is connected to the backlight 260 and the LCD panel 262. The attachment main body section 242 has a screw hole 247 which enables insertion of a screw 248. The screw 248 is for fixing the microdisplay unit 240a at a predetermined position. As a result of the screw 248 being pushed by rotation, the extremity of the screw 248 comes into contact with the L-shaped member 230-1., whereby the position of the microdisplay unit 240a in a rotational direction is fixed.

The backlight 260, the LCD panel 262, and the reflection section 264 are identical in structure with the respective corresponding constituents employed in the first embodiment, and hence their detailed explanations are omitted. Specifically, the backlight 260 is identical in structure with the backlight 60 and is connected continuously to the attachment main body section 242. Further, the LCD panel 262 is identical in structure with the LCD panel 62 and is provided so as to be continuously connected to the backlight 260. The reflection section 264 is identical in structure with the reflection section 64 and is provided so as to be continuously connected to the LCD panel 262. The backlight 260, the LCD panel 262, and the reflection section 264 constitute a microdisplay.

The microdisplay unit 240b is identical in structure with the microdisplay unit 240a, and hence its detailed explanation is omitted. In the microdisplay unit 240b, the rodlike member 230-2 is naturally inserted into the insertion hole 244-1 of the attachment main body section 242, and the L-shaped member 230-3 is inserted into the insertion hole 244-2. The connector 52b is connected to the connection section 246.

As in the case of the first and second embodiments, the display device A3 is also connected to the external information terminal. (e.g., a portable terminal). The harness 50 drawn out of the display device A3 is connected to the information terminal, and transmission of data pertaining to a display image from the information terminal and power supply are performed by way of the harness. Further, entry of information into the information terminal may be performed by way of input keys provided on the information terminal. Alternatively, a keyboard, such as a collapsible keyboard, may be prepared, to thereby enable entry of information by way of the keyboard. For instance, the collapsible keyboard may be set so as to be able to establish Bluetooth communication with the information terminal so that the data entered by way of the collapsible keyboard are transmitted to the information terminal.

Operating state of the display device A3 having the foregoing configuration will now be described. As in the case of the first embodiment, when in use, the display device A3 is mounted on the head as if eyeglasses were worn. Specifically, the display device is worn by fitting the temple sections 20a, 20b around the ears and bringing the nose pad sections 19 into contact with an upper portion of the nose.

At that time, the support section 230 is pivotable, and hence the user can adjust the reflection sections 264 of the microdisplay units 240a, 240b so as to bring the same to appropriate positions. When the support section 230 is desired to be fixed at a predetermined position, the only requirement is to fasten the screw 24. Moreover, the microdisplay units 240a, 240b are rotatable about the support section 230, thereby enabling adjustment of angles of the microdisplay units 240a, 240b. When the microdisplay units 240a, 240b are desired to be firmly secured at a predetermined angle, the only requirement is to fasten the screw 248 provided in the attachment main body section 242.

Data pertaining to a display image are transmitted from the external information terminal connected to the harness 50, whereupon the display image is output from the LCD panel 262. The thus-output display image is displayed on the reflection sections 264. The user can visually as certain the display image by means of staring at the reflection sections 264 of the microdisplay units 240a, 240b.

When the microdisplay units 240a, 240b causes a nuisance for the user, such as when documents or the like are desired to be viewed during the course of use of the display device A3, the support section 230 is rotated so as to move away from the field of view or to the corner of the field of view.

As mentioned above, according to the display device A3 of the embodiment, the eyeglass-shaped frame section 10 is provided with the support section 230, and the microdisplay units 240a, 240b are attached to the support section 230. A sufficient field of view for areas other than the areas of the microdisplay units 240a, 240b can be ensured, thereby ensuring a see-around effect. In the display device A3 of the embodiment, the frame section 10 has the shape of eyeglass frames, and the microdisplay units 240a, 240b are supported on the support section 230 formed in the shape of a rod. Hence, a wide field of view can be ensured.

As mentioned above, the vertical positions of the microdisplay units 240a, 240b can be adjusted by rotating the support section 230, and the angles of the microdisplay units 240a, 240b can be adjusted by means of rotating the microdisplay units 240a, 240b about the support section 230. Hence, the positions of the microdisplay units 240a, 240b can be adjusted to the position where the user can easily view a display image.

As mentioned above, when the microdisplay units 240a, 240b have become a nuisance, the only requirement is to rotate the support section 230, thereby improving the operability of the entire display device.

Although the above descriptions have mentioned that the L-shaped member 230-1, the rodlike member 230-2, and the L-shaped member 230-3 are separate members, they may be constituted in a single piece. In that case, the support section 230 is formed integrally in the form of a C-shaped member. As a result, the support section 230 is inserted into the microdisplay units 240a, 240b.

The following case is conceivable as an improved modification of the third embodiment. To begin with, a first improved example is a structure in which a portion of the support section 230 is removably separated.

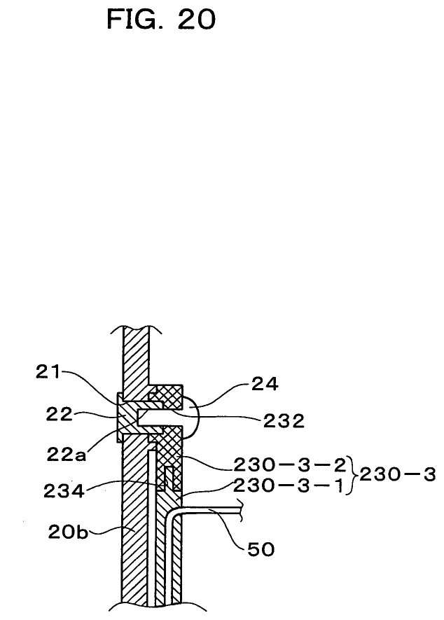

Specifically, as shown in FIG. 20, the insertion hole 21 to be used for securing the attachment section 22 having the screw hole 22a is formed in the temple section 20b. The attachment section 22 is secured in the insertion hole 21, and the temple section 20b and the attachment section 22 are provided with a base section 230-3-2 having the insertion hole 232, and the screw 24 is inserted into the insertion hole 232 of the base section 230-3-2 and fastened to the screw hole 22a of the attachment section 22. As a result, if the screw 24 is fastened loosely, the base section 230-3-2 rotates with respect to the temple section 20b and the attachment section 22. The base section 230-3-2 is a portion of the L-shaped member 230-3. The L-shaped member 230-3 has such a structure that the member can be separated into an L-shaped member main body section 230-3-1 and the base section 230-3-2.

The base section 230-3-2 has a hole section 234 having an elongated longitudinal cross-sectional profile and has a structure for enabling removal and attachment of the L-shaped member main body section 230-3-1. The leading end section of the L-shaped member 230-3-1 is formed slightly narrow so that it can be inserted into the hole section 234.

The structure of the support section on the part of the temple section 20b has been described by reference to FIG. 20. The structure of the support section on the part of the temple section 20a is identical with the structure shown in FIG. 20, except that they are bilaterally symmetrical, and hence its detailed explanations are omitted.

By means of such a structure, a portion of the support section 230 can be separated in a removably attachable manner. When the microdisplay units 240a, 240b are not used, the only requirement is to remove, from the support section 230, predetermined portions of the support section 230; that is, the main body section exclusive of the base section 230-3-2 provided close to the temple section 20b and the base section (not shown) provided close to the temple-section 20a. Particularly, this is effective for a case where the temple sections 20a, 20b are collapsed.

The L-shaped member main body section 230-3-1 shown in FIG. 20 corresponds to the third support section of the second L-shape member, and the base section 230-3-2 corresponds to the fourth support section of the second L-shaped member. Moreover, the L-shaped main body section 230-3-1 provided close to the temple section 20a corresponds to the first support section of the first L-shaped member, and the base section 230-3-2 corresponds to the second support section of the second L-shaped member.

Next, a structure which enables the position of the pivotal center of the support section 230 to be slid along the temple section will now be described as a second improvement.

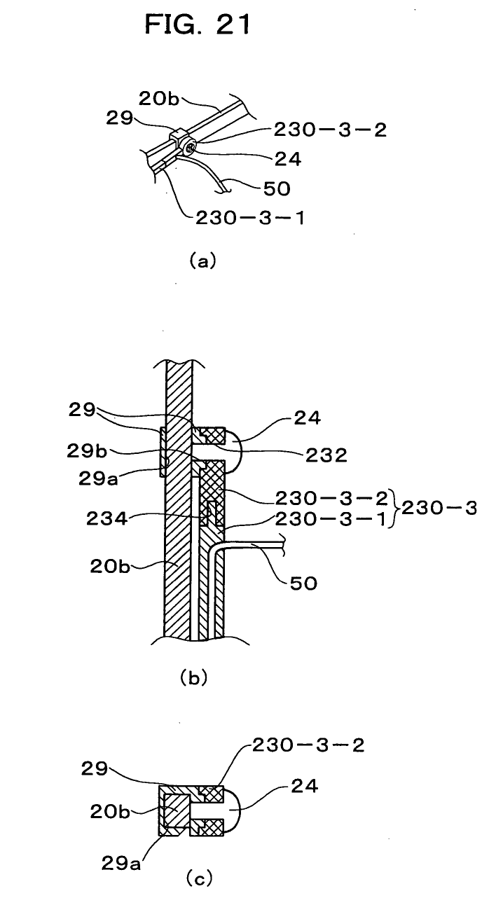

As shown in FIG. 21, the temple section 20b is provided with a slide section 29 which is slidable over the temple section 20b. An insertion hole 29a for enabling penetration of the temple section 20b therethrough is formed in the slide section 29. Further, the slide section 29 is provided with a screw hole 29b for enabling screw-engagement of the screw 24. The base section 230-3-2 having the insertion hole 232 is attached to and remains in contact with the slide section 29. The screw 24 is inserted into the insertion hole 232 of the base section 230-3-2 and fastened into the screw hole 29b of the slide section 29. As a result, the base section 230-3-2 rotates with respect to the temple section 20b and the attachment section 22 by means of weakly fastening the screw 24. The base section 230-3-2 is a portion of the L-shaped member 230-3, and the L-shaped member 230-3 can be separated into the L-shaped member main body section 230-3-1 and the base section 230-3-2.

The hole section 234 having an elongated longitudinal cross-sectional profile is formed in the base section 230-3-2 and has a structure for enabling removal attachment of the L-shaped member main body section 230-3-1. The leading end of the L-shaped main body section 230-3-1 is formed slightly narrow so as to allow insertion into the hole section 234.

Such a structure enables sliding of the slide section 29 and adjustment of the pivotal center of the support section 230. Particularly, the structure enables adjustment of the support section close to the position corresponding to the rotational center of the eyeballs, thereby improving operability to a much greater extent. Further, removal attachment of the support section 230 is feasible. When the microdisplay units 240a, 240b are not used, the only requirement is to remove, from the support section 230, predetermined portions of the support section 230; that is, the main body section exclusive of the base section 230-3-2 provided close to the temple section 20b and the base section (not shown) provided close to the temple section 20a. Particularly, this is effective for a case where the temple sections 20a, 20b are collapsed.

The structure of the support section close to the temple section 20b has been described by reference to FIG. 21. The structure of the support section close to the temple section 20a is identical in structure with that shown in FIG. 20, except that they are bilaterally symmetrical, and hence its detailed explanation is omitted.

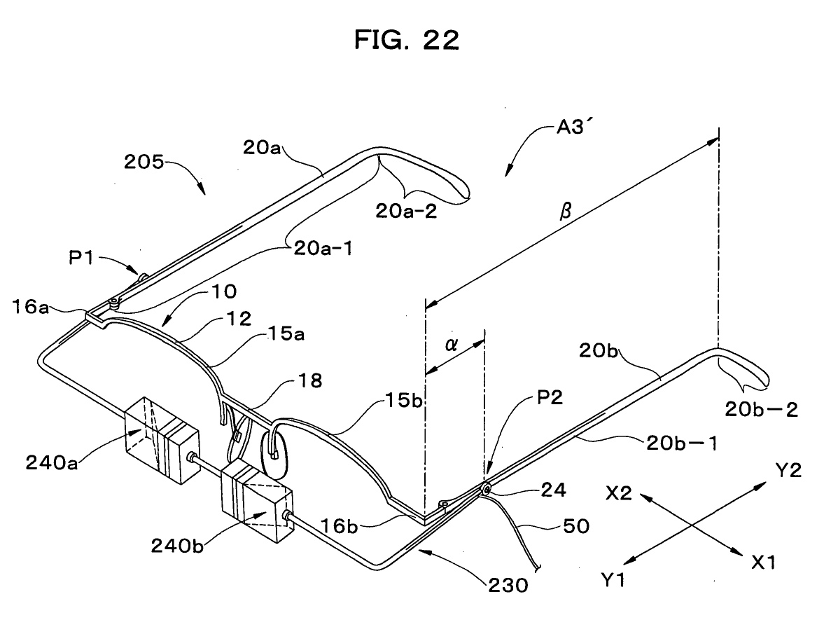

As shown in FIG. 22, a third improvement is that the microdisplay units maybe oriented laterally in connection with the structure shown in FIG. 15. In a display device A3′, the microdisplay unit 240a is attached to the support section 230 in a laterally-oriented position, and the microdisplay unit 240b is attached to the support section 230 in a laterally-oriented position.

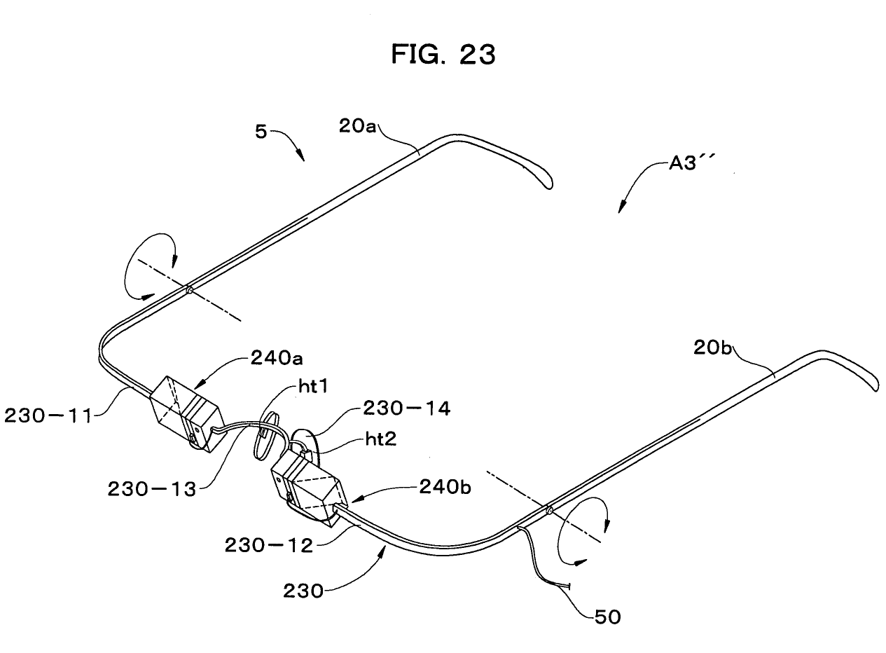

As shown in FIG. 23, a fourth improvement may be embodied by a structure in which the rim and the pivotal portion supporting the microdisplay unit are assembled into a single piece. Specifically, a display device A3″ comprises temple sections 20a, 20b; a support section 230; and microdisplay units 240a, 240b.

As in the case of the previous embodiment, the temple sections 20a, 20b assume the shape of a temple portion of eyeglasses. The support section 230 comprises a first support section 230-11, a second support section 230-12, a third support section 230-13, and nose pad sections 230-14.

The first support section 230-11 assumes the L-shaped geometry which is formed by bending a rodlike member into the L-shaped form. The end of the first support section 230-11 close to the temple section 20a is supported so as to be pivotal with respect to the temple section 20a. More specifically, the end of the first support section 230-11 is pivotally supported by the end of the temple section 20a. Similarly, the second support section 230-12 assumes the L-shaped form which is formed by bending a rodlike member into the L-shaped form. The end of the second support section 230-12 located close to the temple section 20b is supported so as to be pivotal with respect to the temple section 20b. More specifically, the end of the second support section 230-12 is pivotably supported by the end of the temple section 20b. The third support section 230-13 is provided between the microdisplay units 240a and 240b and assumes the shape defined into a substantially-U-shaped form. The nose pad sections 230-14 are attached to the third support section 230-13 and comprise a pair of support sections ht1 fixed to the third support section 230-13, and flat-plate-shaped sections ht2 provided on the support sections ht1. This flat-plate-like section ht2 comes into contact with the user's nose.

The microdisplay unit 240a is fixed between the first support section 230-11 and the third support section 230-13. The microdisplay unit 240b is fixed between the second support section 230-12 and the third support section 230-13. In this case, the microdisplay units 240a, 240b are not rotated with respect to the support section 230 and remain stationary.

Here, the operating state of the display device A3″ will now be described. The user wears the display device A3″ by fitting the temple sections 20a, 20b thereof around the ears. At this time, when the user visually ascertains only the microdisplay units 240a, 240b, the support section 230 remains unfolded with respect to the temple sections 20a, 20b. Namely, the state shown in FIG. 23 is achieved. In this case, the microdisplay units 240a, 240b are provided in line with the front line of the user's eyesight. The user can view images displayed by the microdisplay units 240a, 240b by observing the front. When viewing the images displayed on the microdisplay units 240a, 240b along with the outside view other than the images, the user sets the microdisplay units 240a, 240b to positions slightly lower than the front line of sight while the support section 230 is bent with respect to the temple sections 20a, 20b. By means of such a setting, the user can view the images displayed on the microdisplay units 240a, 240b by means of viewing slightly lower positions as well as being able to view objects located at the front side of the user by casting the line of sight to the front. Hence, the display device is suitable for viewing the images displayed on the microdisplay units 240a, 240b while viewing documents or the like. More specifically, the angles at which the microdisplay units 240a, 240b are oriented can be changed quickly through use of both hands, thereby improving operability.

A hinge mechanism may be provided at an intermediate position of the first support section 230-11, and a hinge mechanism may be provided at an intermediate position of the second support section, thereby enabling collapse of the display device.

The respective embodiments have described that the frame section 10 is not equipped with lenses. However, the embodiments are not limited to such a structure and may adopt a structure in which the frame is equipped with lenses. By means of a structure in which the frame section is provided with lenses, even a user having poor eyesight can view images displayed on microdisplay units.

The respective embodiments have described that the frame section 10 is constituted of the rim section 12 and the temple sections 20a, 20b. However, the rim section 12 may be replaced with lenses, to thereby constitute so-called rimless glasses. Even in such a case, the frame section can be said to serve as the main body section of the eyeglass frame. In that case, according to the first and second embodiments, the lenses are equipped with a support section.

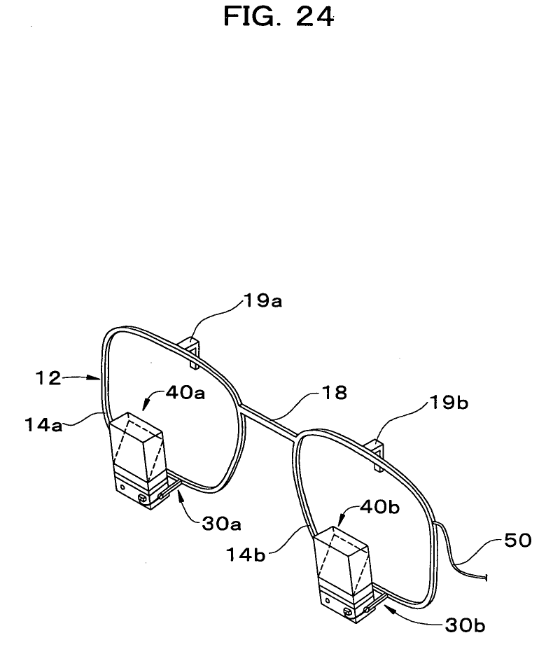

In the first and second embodiments, the structure of the temple section in the frame section 10 may be deleted, and the rim section 12 may be provided with a removal/attachment mechanism for enabling removal attachment of the display device to existing eyeglasses. Specifically, as shown in FIG. 24, the rim section 12 comprises frame-shaped edge sections 14a, 14b; and the bridge section 18. As in the case of the first embodiment, the support sections 30a, 30b and the microdisplay units 40a, 40b are provided at lower end positions of the edge sections 14a, 14b. The edge sections 14a, 14b have latch sections 19a, 19b for enabling removal attachment of the display device to eyeglasses. The edge sections 14a, 14b are not equipped with lenses. In contrast with the rim sections described in connection with the first through third embodiments, the rim section 12 shown in FIG. 24 is not provided with endpiece sections. The structures of the support sections 30a, 30b, the structures of the microdisplay units 40a, 40b, and wiring of the harness 50, all being shown in FIG. 24, are identical with those described in connection with the first embodiment, and hence their detailed descriptions are omitted.

By means of the structure which enables removal attachment of the display device from and on eyeglasses, the user who wears ordinary eyeglasses can also utilize the display device. Particularly, the microdisplay units 40a, 40b are attached to the frame-shaped rim section 12 by way of the support sections 30a, 30b, thereby enabling assurance of a wide field of view.

As mentioned previously, the structure—which omits the temple sections 20a, 20b and the endpiece sections 16a, 16b from the frame section 10 and provides latch sections to be used for removal attachment of eyeglasses—can also be applied to the display device of the type shown in FIG. 7 and the display device of the type shown in FIG. 8, both types belonging to the first embodiment, as well as to the type of the display device of the second embodiment.

The first and second embodiments have described that support sections 30a, 30b, 130a, and 130b are fixed to the frame section 10. However, the support sections may be configured so as to be removable from the frame section 10.

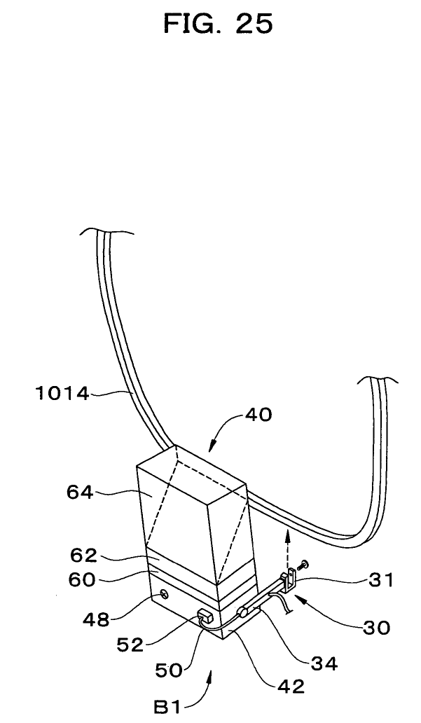

Specifically, a display device B1 shown in FIG. 25 is a modification of the first embodiment and comprises a support section 30 and a microdisplay unit 40. Specifically, the display device B1 has solely the support section 30a (30b) and the microdisplay unit 40a (40b) in the embodiment shown in FIG. 1, wherein the support section is equipped with a removal/attachment mechanism. In FIG. 25, the support section 30 is identical in structure with a support section 30a of the first embodiment and is equipped with a removal/attachment section 31. Specifically, the removal/attachment section 31 is provided at the end along with the first and section latch sections 32, 34. The removal/attachment section 31 is intended for enabling removal and attachment of the display device from and to an edge section 1014 of the rim section of ordinary eyeglasses. The removal/attachment section 31 is formed so as to assume a C-shaped cross-sectional profile and has a screw hole to be used for enabling insertion of a screw. After fitting of the removal/attachment section 31, the screw is fastened, thereby enabling attachment of the support section 30 to an edge section 1014. The microdisplay unit 40 is identical in configuration with that of the first embodiment, and hence its detailed explanation is omitted. FIG. 25 shows an example in which the display device B1 is attached to the left edge section 1014 of the eyeglass. However, the display device can also be attached to the right edge section.

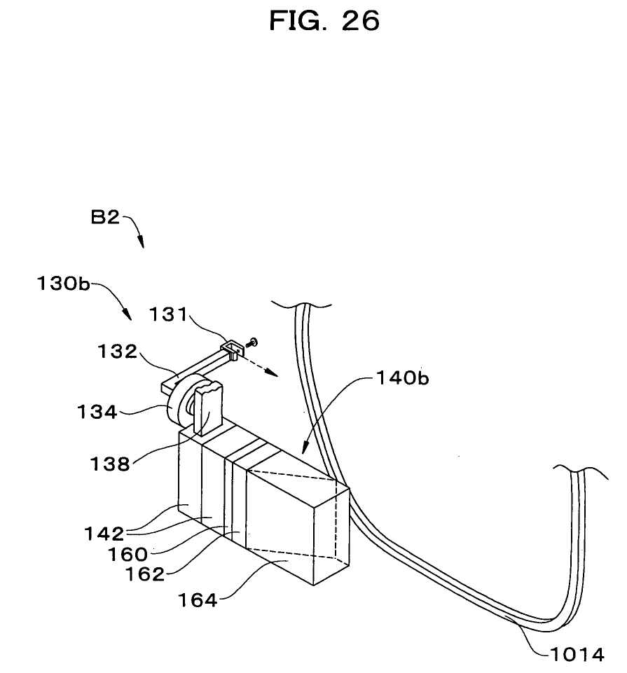

As shown in FIG. 26, a display device B2 is a modification of the second embodiment. The display device B2 is constituted of solely the support section 130a (130b) and the microdisplay unit 140a (140b) in the second embodiment, wherein the support section is equipped with a removal/attachment mechanism. An example in which the display device is removably attached to the left edge section 1014 of the eyeglasses is shown in FIG. 26. The support section 130b is identical in configuration with the support section 130b of the first embodiment and is equipped with a removal/attachment section 131. The removal/attachment section 131 is identical in structure with the removal/attachment section 31, and hence its detailed explanation is omitted. Further, the support section 130b is identical in configuration with the support section of the second embodiment, except for provision of the removal/attachment section 131, and hence its detailed explanation is omitted. The microdisplay unit 140b is identical in structure with the microdisplay of the first embodiment, and hence its detailed explanation is omitted. FIG. 26 shows an example in which the display device B2 is attached to the left edge section 1014 of eyeglasses. The display device is identical in structure with the display device B2 shown in FIG. 26, except that the display device becomes bilaterally symmetrical when attached to the right edge section, and hence its detailed explanation is omitted.

As shown in FIGS. 25 and 26, the display device is removably attached to ordinary eyeglasses. As a result, even a user wearing ordinary eyeglasses can utilize the display device. Particularly, the microdisplay units can be attached to the edge sections of the rim section of eyeglasses via a support section, and hence a wide field of view can be ensured.

### INDUSTRIAL APPLICABILITY

As has been described, according to the display device of the invention, the main body section has the shape of eyeglasses, and the main body section is equipped with display sections. When this display device is worn, only the main body section other than the display sections obstructs the field of view. Hence, the field of view outside the display sections can be ensured sufficiently.

Similarly, the display device of the invention has a frame section having the shape of eyeglasses, and the display section is attached to the frame section by way of a support section or the like. Hence, when the display device is worn, only the frame section and the support section other than the display sections obstruct the field of view. Hence, a field of view outside the display sections can be ensured sufficiently.

Even when the display device is not provided with the temple sections and the rim section has display sections, only the rim section other than the display sections obstructs the field of view when the display device is in use. Therefore, the field of view other than the display sections can be ensured sufficiently. Even when an action for viewing documents or the like is performed while the display device is used, the only requirement is to change merely the direction of the user's line of sight, and hence the display device can be made superior in operability.

When the support section is pivotally supported by the temple sections of the frame section, the vertical positions of the display sections can be adjusted by means of rotating the support section. Further, when the display sections have become interruptive, the only requirement is to rotate the support section, thereby improving the overall operability of the display device.

When the display device has the support section having a removal/attachment mechanism to be used for removal attachment of the display device to eyeglasses and the display sections supported by the support section, the field of view outside the display sections can be ensured sufficiently. Further, the display device can be attached to the eyeglasses, and hence a user who ordinarily uses eyeglasses can attach the display sections by utilization of the eyeglasses, thus providing convenience.

1. A display device comprising:
a frame section of eyeglass type having a rim section, the rim section being located in-front of a user's face when said display device is mounted on the head, and a pair of temple sections connected to respective sides of said rim section; and
a display section which is attached to said frame section and has a microdisplay.

2. The display device according to claim 1, wherein said rim section has downward portions which are located side by side at positions downward of the user's eyes when said display device is mounted on the head, and said display section is attached to each of the downward portions.

3. The display device according to claim 1, wherein said rim section has interior portions which are situated at positions within an area between the user's eyes when said display device is mounted on the head, and said display section is attached to said interior sections.

4. The display device according to claim 1, wherein said display section is attached to said frame section so as to be rotatable about a lateral axis of said display device with respect to said frame section.

5. The display device according to claim 1, wherein said display section is provided at a position downward of a front direction of the user who has worn the display device.

6. The display device according to claim 1, wherein said display section is attached to said frame section so as to be movable in a moving direction having vertical components of said display device.

7. The display device according to claim 1, wherein said display section is attached to said frame section so as to be movable over a circular-arc-shaped travel path which, with respect to said frame section, is movable in a moving direction having vertical components of said display device.

8. A display device comprising:
a rim section having a removal/attachment mechanism to be used for removal attachment of said display device to eyeglasses; and
a display section which is mounted on said rim section and has a microdisplay.

9. A display device comprising:
a frame section of eyeglass type having a rim section, the rim section being located in front of a user's face when said display device is mounted on the head, and a pair of temple sections connected to respective sides of said rim section;
a support section attached to said frame section; and
a display section which is attached to said support section and has a microdisplay.

10. The display device according to claim 9, wherein said rim section has downward portions which are located side by side at positions downward of the user's eyes when said display device is mounted on the head, and said support section is attached to each of the downward portions.

11. The display device according to claim 9, wherein said rim section has interior portions which are situated at positions within an area between the user's eyes when said display device is mounted on the head, and said support section is attached to said interior sections.

12. The display device according to claim 9, wherein said display section is attached to said support section so as to be rotatable about a lateral axis of said display device with respect to said support section.

13. The display device according to claim 9, wherein said display section is provided at a position downward of a front direction of the user who has worn the display device.

14. The display device according to claim 9, wherein said display section is attached to said support section so as to be movable in a moving direction having vertical components of said display device.

15. The display device according to claim 9, wherein said display section is attached to said support section so as to be movable over a circular-arc-shaped travel path which, with respect to said support section, is movable in a moving direction having vertical components of said display device.

16. The display device according to claim 9, wherein said support section is attached to said frame section so as to be movable in a moving direction having vertical components of said display device.

17. The display device according to claim 9, wherein said support section is attached to said frame section so as to be movable over a circular-arc-shaped travel path which is movable in a moving direction having vertical components of said display device.

18. The display device according to claim 9, wherein said support section is removable and attachable from and to said frame section.

19. The display device according to claim 9, wherein said support section is rotatably supported by said temple section of said frame section.

20. The display device according to claim 15, wherein said circular-arc-shaped travel path is located on a circular arc centered at the rotational center of the eyeballs of the user who has worn the display device.

21. The display device according to claim 15, wherein said circular-arc-shaped travel path has a radius of 20 mm to 45 mm.

22. The display device according to claim 19, wherein said support section is slidably supported by said temple section.

23. The display device according to claim 19, wherein the position where said support section is supported by said temple section is separated from an end section of said temple section close to said rim section by 20 mm to 45 mm.

24. The display device according to claim 19, wherein said rim section has at each end thereof an endpiece section to be used for connecting said rim section with said temple section, and
the location where said support section is supported by 10 said temple section is located at an end section of said endpiece section and separated from a forward end section of said display device by 20 mm to 45 mm.

25. A display device comprising:
a rim section having a removal/attachment mechanism to be used for removal attachment of said display device to eyeglasses;
a support section attached to said rim section; and
a display section which is attached to said support section and has a microdisplay.

26. A display device comprising:
a display section having a microdisplay; and
a main body section which supports said display section and has a pair of temple sections, said temple sections coming into contact with respective sides of a user's head when said display device is worn, and a support section, said support section being rotatably supported by said temple sections and supporting said display section.

27. The display device according to claim 26, wherein said support section has
a first support section which is rotatably supported by a right temple section and supports a right display section;
a second support section which is rotatably supported by a left temple section and supports a left display section; and
a third support section for supporting said right display section and said left display section.

28. A display device comprising:
a support section having a removal/attachment mechanism for removal attachment of said display device to eyeglasses; and
a display section which is supported by said support section and has a microdisplay.

29. The display device according to claim 28, wherein said display section is rotatably attached to said support section, with respect to said support section.

30. The display device according to claim 28, wherein said display section is attached to said support section so as to be movable over said support section.
